(19) United States
(12) Patent Application Publication
(10) Pub. No.: US 2021/0119210 A1
(43) Pub. Date: Apr. 22, 2021

(54) LITHIUM/SULFUR BATTERY WITH INCREASED CAPACITY AND ASSOCIATED PROCESSES

(71) Applicant: Arkema France, Colombes (FR)

(72) Inventors: Alexander Korzhenko, Pau (FR); Pierre-Thomas Skowron, Gelos (FR); Paul-Guillaume Schmitt, Lescar (FR); Meriem Anouti, St Avertin (FR)

(73) Assignee: Arkema France, Colombes (FR)

(21) Appl. No.: 17/047,595

(22) PCT Filed: Apr. 19, 2019
(86) PCT No.: PCT/FR2019/050957

§ 371 Date: Oct. 14, 2020

(30) Foreign Application Priority Data
Apr. 20, 2018 (FR) 1853528

(51) Int. Cl. H01M 4/583; H01M 4/36; H01M 4/38; H01M 4/04; H01M 4/62; H01M 10/36

(52) U.S. Cl. CPC H01M 4/583; H01M 4/364; H01M 4/38; H01M 2300/0025; H01M 4/622; H01M 10/36; H01M 4/0471

(57) ABSTRACT

A new class of alkoxyamines is described that exhibits improved stability on storage, especially in the presence of monomers and/or of a solvent, and particularly where the alkoxylamines are a new class of oligomeric alkoxyamines, which are obtained by addition of one or more monomeric entities to an alkoxyamine.

### CROSS-REFERENCE TO RELATED APPLICATIONS

This is the national phase of International Application No. PCT/FR2019/050957, filed 19 Apr. 2019, which claims priority to French Application No. 1853528, filed 20 Apr. 2018. The disclosure of each of these applications is incorporated herein by reference in its entirety for all purposes.

The present invention relates to the field of batteries and more specifically sulfur-based batteries of high energy density and high power. In particular, the present invention relates to a battery comprising a composite material comprising sulfur and carbon, which has improved performance. The invention also relates to a process for preparing such a battery.

### BACKGROUND OF THE INVENTION

The development of rechargeable batteries with a high energy density is of very great technological and commercial interest. Such batteries already equip portable electronic systems (e.g. Li-ion batteries) or hybrid cars (e.g. Ni-MH batteries). However, on account of the increasing energy demand for electronic, transportation and network storage applications, there is a greater need for batteries with increasingly large storage and discharging capacities.

Sulfur-based accumulator batteries, such as lithium/sulfur (Li/S) accumulator batteries or Li/S batteries, are envisaged as promising alternatives to Li-ion batteries. In addition, sodium-sulfur batteries have high storage capacities and are mainly used in support for renewable energy sources. Specifically, sulfur has the advantages of being abundant, light, inexpensive and nontoxic, which makes it possible to envisage the large-scale development of sulfur-based batteries. In addition, the interest in this type of battery arises notably from the high potential energy density of sulfur. Specifically, the electrochemical conversion of elemental sulfur into sulfide ion (S²⁻) offers a theoretical capacity of 1675 mAh/g compared with less than 300 mAh/g for a conventional Li-ion cell cathode.

Nevertheless, the development of conventional Li—S batteries continues to suffer from a relatively rapid decrease in capacity on cycling. Thus, the Applicant proposed to add an organosulfur component comprising an —S—Sₙ— bond, where n is greater than or equal to 1, to the electrolyte, to the cathode or to the separator so as to prevent the formation of insoluble lithium sulfide species (e.g. LiS and LiS₂), thus reducing their deposition in the battery elements and the loss of reactive species during repeated charging/discharging cycles. This made it possible to observe good cycling stability of the battery (CN106058229). In addition, it has been proposed to modify the functionalities of these organosulfur species so as to control their distribution in the cathode/catholyte. However, the batteries proposed including such features have a capacity of the order of 200 mAh/g (WO 2013/155038) or 400 W/kg (EP 0739544).

Sulfur is a cathode active material that is very appealing on account of its very high theoretical specific capacity of 1672 mAh/g, which is very much higher than that of any conventional active material. However, its major drawback is the low electronic and ion conductivity of sulfur. Usually, the formulation of the sulfur-based cathode contains, in addition to sulfur, a carbon-based electrical conductor and a large proportion of the prior art relating to the architecture of the Li—S battery is dedicated to optimizing the sulfur-carbon ratio in the cathode or to the use of other forms of carbon such as carbon nanotubes (CNT).

CNTs prove to be difficult to handle and to disperse, due to their small size, to their pulverulence and possibly, when they are obtained by chemical vapor deposition, to their entangled structure generating strong Van Der Waals interactions between their molecules. Mixing of the active material and of the conductive additive may be performed in various ways. A sulfur-carbon composite, more particularly a sulfur-CNT composite, formed in the melt enabling the cathode to be made more conductive was proposed by the Applicant (WO 2016/066944). This is an approach that makes it possible to reduce the amount of carbon-based filler required for the functioning of the cathode, and thus to increase the sulfur content in the cathode. However, batteries based on such an active material have shown capacities of the order of 1250 mAh/g at a C/10 regime which are lower than the theoretical capacity of sulfur of 1672 mAh/g (WO 2016/102942).

In addition, electrochemical cells including organosulfur species that are capable of improving the performance of such electrochemical cells in the course of repeated discharging and charging cycles of batteries have been proposed (US 2017/084953); others have also shown an increase in capacity (US 2014/170459 and Shuru Chen et al. 2016, Angew. Chem. Int. Ed. 2016, 55, 4231-4235).

Thus, despite the improvements in cycling stability obtained with the methods of the prior art, there is a need for batteries which have a high capacity and an increased cycling speed.

The invention thus aims to overcome the drawbacks of the prior art. In particular, the aim of the invention is to propose a sulfur-based battery with improved capacity. The aim of the invention is also to propose a sulfur-based battery with faster cycling.

The aim of the invention is also to propose a process for preparing such a battery, said process being rapid and simple to perform.

### SUMMARY OF THE INVENTION

The present invention relates to a battery comprising an anode, a separator, a cathode comprising a composite material based on sulfur and carbon-based material, and a catholyte, characterized in that the catholyte includes at least one organosulfur species participating in the capacity of the cathode and preferably in that the composite material has been formed in the melt.

As shall be presented hereinbelow, the battery according to the invention has a higher specific capacity than the specific capacity observed for sulfur-based batteries. Specifically, the Li—S batteries of the prior art have initial discharging capacities of less than 1670 mAh/g with a majority of the initial discharging capacities of the order of 1000 mAh/g, whereas the battery according to the invention has an initial discharging capacity generally greater than 1800 mAh/g. In addition, as shall be presented, the battery according to the invention can dispense with the forming step that is generally essential for the placing in function of the battery.

According to other advantageous features of the battery:
the anode comprises an anode active material comprising sodium or lithium. Preferably, the anode may comprise lithium. Specifically, a lithium-sulfur battery according to the invention makes it possible to achieve unequalled discharging capacities.
the composite material has been formed in the melt, for example via a step of melting the sulfur and of blending the sulfur and the carbon-based material. The use of a composite formed in the melt enables intimate mixing of the sulfur and of the carbon-based material so as to improve the battery performance.
the carbon-based material is selected from: carbon black, carbon nanotubes, carbon fibers, graphene, acetylene black, graphite, carbon nanofibers and a mixture thereof in all proportions. Preferably, the carbon-based material is selected from: carbon nanotubes, carbon nanofibers, graphene and a mixture thereof in all proportions.
the composite material comprises sulfur in elemental form.
the composite material also includes selenium. Specifically, the presence of selenium, preferably in low concentration, makes it possible to protect the cathode
the at least one organosulfur species is selected from: an organic disulfide, an organic polysulfide, a thiol, a polythiol, a thiolate or a polythiolate.
the at least one organosulfur species is selected from the compounds having the following formulae: RSₓR, R(SH)ₙ, R(SM)ₓ, R(COSH)ₙ, R(COSM)ₙ, RCOSₓR and a polymer including one or more functions from among —Sₓ—, —COSₓ—, —SH, —SM, —COSH and —COSM,
with:
M selected from Li and Na;
R selected from substituted or unsubstituted alkyl or aryl groups,
x an integer greater than or equal to 2,
n an integer greater than or equal to 1.
the catholyte also comprises:
   one or more alkali metal salts, such as ATFSi, AFSi, ANO₃, ATDI, ACF₃SO₃,
   mineral and organic polysulfide salts of A_{z}Sₓ and RSₓA, or
   mixtures thereof,
with R selected from substituted or unsubstituted alkyl or aryl groups,
   A selected from Li, Na, K, Rb and Cs,
   x an integer greater than or equal to 2, and
   z an integer greater than or equal to 2.
the catholyte also comprises one or more lithium salts, such as LiTFSi, LiFSi, LiTDI, LiNO₃, LiCF₃SO₃, and mixtures thereof, and the Li polysulfides: RS_{y}Li with y an integer greater than or equal to 2 and R selected from substituted or unsubstituted alkyl or aryl groups.
the catholyte may also comprise a polymeric binder.
the at least one organosulfur species is a polymer and is capable of behaving like a polymeric binder.
the at least one organosulfur species acting as polymeric binder is selected from a polymer containing the following functions: disulfide —S—S—, polysulfides —Sₙ— with n an integer greater than or equal to 2, and/or —SH. The organosulfur species may then be selected, for example, from: polyethylene sulfide, polydisulfide, polyphenyl sulfide, poly(1,8-dimercapto-3,6-dioxaoctane), and/or polysulfideDMDO. The disulfide —S—S— and polysulfide —Sₙ— functions with n being an integer greater than or equal to 2 are preferably borne by the main chain of the polymer whereas the —SH functions are preferably on the side chains.
the organosulfur species participating in the capacity of the cathode are present in the catholyte in a concentration of greater than or equal to 0.05 mol/L. Preferably, the organosulfur species participating in the capacity of the cathode are present in the catholyte in a concentration of greater than or equal to 0.1 mol/L, more preferably greater than or equal to 0.2 mol/L and even more preferably greater than or equal to 0.25 mol/L
it includes mineral sulfur and organic sulfur and the mole ratio between the mineral sulfur and the organic sulfur is between 0.05 and 10 and preferably between 0.1 and 7.
the cathode has a theoretical specific capacity of greater than 1700 mAh/g
the cathode has a specific capacity of greater than 1300 mAh/g measured at a discharging regime equal to C/10. Preferably, the cathode has a specific capacity of greater than or equal to 1500 mAh/g measured at a discharging regime equal to C/10, and more preferably greater than or equal to 200 mAh/g. This value is measured, for example, at 25° C.
the cathode has a specific capacity of greater than 500 mAh/g measured at a discharging regime equal to C/1. Preferably, the cathode has a specific capacity of greater than or equal to 800 mAh/g measured at a discharging regime equal to C/1, more preferably greater than or equal to 1700 mAh/g and more preferably greater than or equal to 2000 mAh/g. This value is measured, for example, at 25° C.
the cathode is capable of having a specific capacity of greater than 1000 mAh/g measured at a discharging regime equal to C/1 after 400 cycles. This value is measured, for example, at 25° C.
the battery does not require a forming step.

According to another aspect, the invention also relates to a process for manufacturing a battery according to the invention, characterized in that it comprises:
a step of preparing a catholyte including at least one organosulfur species participating in the capacity of the cathode and
a step of assembling an anode, a cathode, a separator and catholyte.

According to other advantageous features, the manufacturing process according to the invention does not include a step of forming the battery after the assembly step.

### BRIEF DESCRIPTION OF THE DRAWINGS

Other advantages and features of the invention will become apparent on reading the following description given by way of illustrative and nonlimiting example, with reference to the appended figures, which depict:

FIG. 1: a schematic representation of a battery according to the invention;

FIG. 2: a schematic representation of steps performed in accordance with the invention during the process for preparing a composite material used in the invention; The steps with dashed lines are optional;

FIG. 3: a charging/discharging galvanostatic profile at C/10 showing the initial discharging capacity in the absence of an organosulfur species (the dashed curve) and in the presence of 0.4 M of DMDO (solid-line curve);

FIG. 4: a charging/discharging galvanostatic profile at C/10 for cycles 1 and 20 in the presence of 0.2 M of DMDO;

FIG. 5: a curve of aging of an Li—S battery including the organosulfur species diphenyl disulfide at 0.2 M, illustrating the discharging capacity (solid squares) and the efficiency (empty circles) at a regime of C.

### DETAILED DESCRIPTION OF THE INVENTION

In the rest of the description, the term “catholyte” denotes an electrolyte which can participate in the discharging capacity by means of its reversible reduction on charging and which may notably include the components of an active material which form a cathode.

The term “polymeric binder” means a polymer which, in combination with a salt, can form a polymeric electrolyte. The polymeric binder may be capable of forming a solid polymeric electrolyte or a gelled polymeric electrolyte.

The term “solvent” means a substance, which is liquid or supercritical at its working temperature, and which has the property of dissolving, diluting or extracting other substances without chemically modifying them and without being modified itself. The “liquid-phase solvent” is a solvent in liquid form.

The term “sulfur-carbon composite” means an assembly of at least two immiscible components whose properties complement each other, said immiscible components including a sulfur-based material and a carbon-based nanofiller. The term “sulfur-based material” means a sulfur donor chosen, for example, from vulcanizing agents and preferably selected from native sulfur (or sulfur in elemental form), organosulfur compounds including polymers, and inorganic sulfur compounds. Preferably, the sulfur-based material is sulfur in elemental form.

The term “sulfur in elemental form” means sulfur particles in a crystalline S₈ form or in an amorphous form. More particularly, this corresponds to sulfur particles in elemental form not including any sulfur associated with carbon originating from the carbon-based nanofillers.

In the present invention, the term “carbon-based material” means a material essentially comprising carbon, i.e. comprising at least about 80% by mass of carbon, preferably at least about 90% by mass of carbon, more preferably at least about 95% by mass of carbon.

The term “carbon-based nanofiller” may denote a filler comprising at least one element from the group formed from carbon nanotubes, carbon nanofibers and graphene, or a mixture thereof in all proportions. Preferably, the carbon-based nanofillers comprise at least carbon nanotubes. The term “nanofiller” usually denotes a carbon-based filler, the smallest dimension of which is between 0.1 and 200 nm, preferably between 0.1 and 160 nm and more preferably between 0.1 and 50 nm, measured by light scattering.

According to the invention, the term “compounding device” refers to apparatus conventionally used in the plastics industry for melt mixing thermoplastic polymers and additives for the purpose of producing composites. In this apparatus, the sulfur-based material and the carbon-based nanofillers are mixed by means of a device with high shear, for example a co-rotating twin-screw extruder or a co-kneader. The molten material generally leaves the apparatus in an agglomerated solid physical form, for example in the form of granules.

The term “polymer” means either a copolymer or a homopolymer. The term “copolymer” means a polymer grouping together several different monomer units and the term “homopolymer” means a polymer grouping together identical monomer units. The term “block copolymer” means a polymer comprising one or more uninterrupted sequences of each of the separate polymer species, the polymer sequences being chemically different from each other and being bonded to each other via a covalent bond. These polymer sequences are also known as polymer blocks.

For the purposes of the invention, the term “radical initiator”, denotes a compound that can start/initiate the polymerization of a monomer or monomers.

For the purposes of the invention, the term “polymerization” denotes the process of conversion of a monomer or of a blend of monomers into a polymer.

For the purposes of the invention, the term “monomer” denotes a molecule which can undergo a polymerization.

The term “branched or linear or cyclic, saturated or unsaturated group composed of 1 to 20 carbons” as used in the present invention corresponds to a saturated, linear, cyclic or branched hydrocarbon-based chain containing from 1 to 20 carbon atoms or to an unsaturated, linear, cyclic or branched hydrocarbon-based chain containing from 2 to 20 carbon atoms. A saturated linear, cyclic or branched hydrocarbon-based chain containing from 1 to 20 carbon atoms comprises, without being limited thereto, methyl, ethyl, n-propyl, isopropyl, n-butyl, isobutyl, sec-butyl, t-butyl, n-pentyl groups, and the like. An unsaturated linear or branched hydrocarbon-based chain containing from 2 to 20 carbon atoms comprises at least one double bond or one triple bond, and includes, without being limited thereto, ethenyl, propenyl, butenyl, pentenyl, ethynyl, propynyl, butynyl, pentynyl groups, and the like.

As used in the present invention, the term “(C₁-C₁₂)alkyl” denotes a substituted or unsubstituted, saturated, linear or branched alkyl group including between 1 and 12 carbon atoms, which may comprise at least one heteroatom, for instance N or O.

As used in the present invention, the term “(C₂-C₁₂)alkenyl” denotes a substituted or unsubstituted, unsaturated, linear, branched or cyclic alkyl group including between 2 and 12 carbon atoms and at least one double bond, which may comprise at least one heteroatom, for instance N or O.

As used in the present invention, the term “(C₂-C₁₂)alkynyl” denotes a substituted or unsubstituted, unsaturated, linear, branched or cyclic alkyl group including between 2 and 12 carbon atoms and at least one triple bond, which may comprise at least one heteroatom, for instance N or O.

As used in the present invention, the term “cycloalkyl” denotes a substituted or unsubstituted, saturated, cyclic alkyl group which may comprise at least one heteroatom, for instance N or O.

As used in the present invention, the term “aryl” denotes an aromatic hydrocarbon-based group preferably comprising 6 to 10 carbon atoms and comprising one or more, notably 1 or 2, fused rings, for instance a phenyl group or a naphthyl group. Advantageously, this denotes a phenyl group.

As used in the present invention, the term “heteroaryl” denotes a monocyclic, bicyclic or tricyclic aromatic radical, containing a total of from 3 to 13 atoms, among which 1, 2, 3 or 4 are chosen, independently of each other, from nitrogen, oxygen and sulfur, optionally in oxidized form (in the case of nitrogen and sulfur), the other atoms being carbon atoms, said heteroaryl radical being optionally substituted with one or more identical or different chemical species.

As used in the present invention, the term “alkylaryl” denotes an aryl group as defined above linked to the molecule via an alkyl group. In particular, as used in the present invention, the term “—(C₁-C₁₂ alkyl)aryl” denotes an aryl group as defined above linked to the molecule via a C1 to C12 alkyl group as defined above. In particular, the —(C₁-C₁₂ alkyl)aryl group according to the invention is a propane-phenyl group. As used in the present invention, the term “arylalkyl” denotes an aryl group as defined above, substituted with an alkyl group and linked to the molecule via the aryl group. This corresponds, for example, to a benzyl.

For the groups comprising two or more subgroups, the attachment is indicated by “-”. For example, “—(C₁-C₅ alkyl)aryl” denotes an alkyl radical linked to an aryl radical in which the alkyl is linked to the rest of the molecule. For the groups comprising an attachment at each end, for example “—(C₁-C₅ alkyl)aryl-”, this denotes an alkyl radical linked to an aryl radical in which the alkyl or the aryl are linked to the rest of the molecule and this also encompasses both a —(C₁-C₅ alkyl)aryl- group and an -aryl(C₁-C₅ alkyl)- group.

The groups according to the invention, for example the alkyl, alkenyl, aryl, heteroaryl or cycloalkyl groups, may be optionally substituted according to the present invention with one or more groups chosen independently from the group consisting of alkyl, alkoxyl, hydroxyl, carboxyl, ester, thiol or thiolate. Examples of optionally substituted phenyl groups are methoxyphenyl, dimethoxyphenyl and carboxyphenyl. Alternatively, they are substituted only if this is explicitly specified. The term “optionally substituted” as used herein means that any one of the hydrogen atoms may be replaced with a substituent, such as an alkyl, alkoxyl, hydroxyl, carboxyl, ester, thiol or thiolate group.

The invention is now described in greater detail and in a nonlimiting manner in the description that follows. In the rest of the description, the same reference numerals are used to denote the same elements.

As presented in the examples, the inventors have developed a novel generation of sulfur-based battery, the cathode of which has improved capacity.

Specifically, whereas the lithium-sulfur batteries developed in recent years are generally limited to capacities of less than 1300 mAh·g⁻¹ (cf. table 1), the battery according to the invention makes it possible in certain embodiments to achieve a capacity of greater than 2000 mAh·g⁻¹.

To do this, the inventors developed a battery, the catholyte of which includes an organosulfur species which participates in the capacity of the cathode. As shall be detailed hereinbelow, the presence of the organosulfur species makes it possible to increase the capacity of the cathode to hitherto unequalled levels.

In addition, the organosulfur species makes it possible to eliminate the tedious first charging and discharging step.

### The Battery

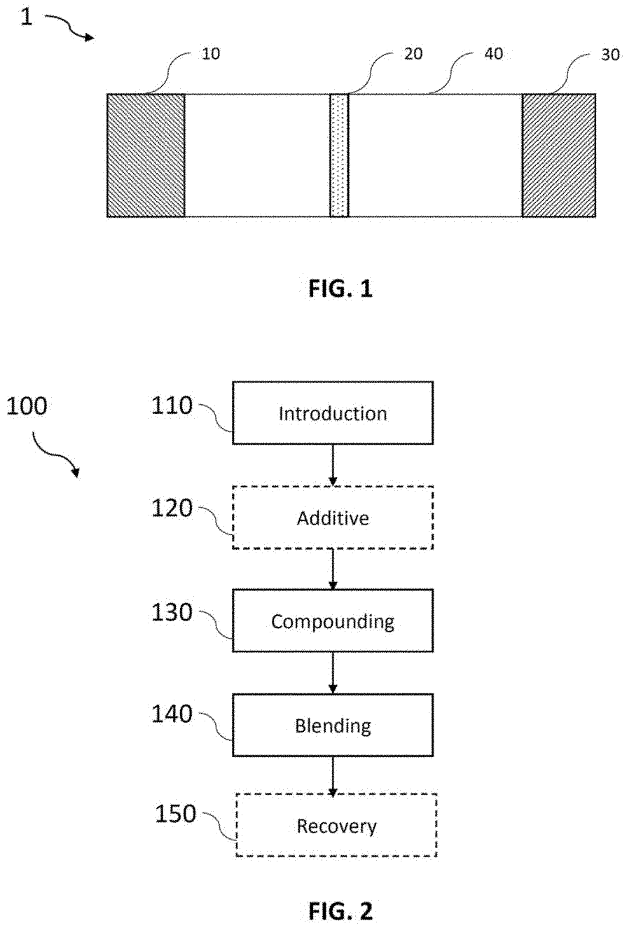

Thus, according to a first aspect, the invention relates to a battery comprising an anode 10, a separator 20, a cathode 30 comprising a composite material based on sulfur and carbon-based material, and a catholyte 40 including at least one organosulfur species participating in the capacity of the cathode. Such a battery is represented in FIG. 1.

The battery according to the invention is more particularly a rechargeable battery.

### The Catholyte

At 25° C., the catholyte may be liquid, gelled or solid. The state of the catholyte at 25° C. may be predetermined and will depend on the specifications of the battery incorporating said catholyte.

As has been mentioned, the battery according to the invention may notably be characterized in that the catholyte includes at least one organosulfur species participating in the capacity of the cathode.

In particular, the catholyte includes at least one organosulfur species participating in the capacity of the cathode in a concentration of greater than or equal to 0.05 mol/L, preferably greater than or equal to 0.1 mol/L, more preferably greater than or equal to 0.2 mol/L and even more preferably greater than or equal to 0.25 mol/L.

For example, the catholyte includes at least one organosulfur species participating in the capacity of the cathode in a concentration of between 0.05 and 1 mol/L, preferably between 0.1 and 0.6 mol/L, more preferably between 0.2 and 0.5 mol/L and even more preferably between 0.25 and 0.45 mol/L. The limits are included.

As shall be detailed hereinbelow, the organosulfur species participating in the capacity of the cathode may include several functions that are capable of improving the capacity of the cathode, for example at least one reactive species of the type —S—Sₙ— or of the type —SH or —SM, with n ranging from 1 to 5, and M possibly being a sodium, a lithium, or a quaternary ammonium, sulfonium or phosphonium.

Thus, particularly, the catholyte includes at least one organosulfur species participating in the capacity of the cathode, in a concentration such that the concentration of the reactive function —S—Sₙ— is greater than or equal to 0.05 mol/L, preferably greater than or equal to 0.1 mol/L, more preferably greater than or equal to 0.2 mol/L and even more preferably greater than or equal to 0.25 mol/L.

For example, the catholyte includes at least one organosulfur species participating in the capacity of the cathode in a concentration such that the concentration of the reactive function —S—Sₙ— is between 0.05 and 1 mol/L, preferably between 0.1 and 0.6 mol/L, more preferably between 0.2 and 0.5 mol/L and even more preferably between 0.25 and 0.45 mol/L. The limits are included.

Alternatively, the catholyte includes at least one organosulfur species participating in the capacity of the cathode, in a concentration such that the concentration of the reactive function —SH or —SM is greater than or equal to 0.1 mol/L, preferably greater than or equal to 0.2 mol/L, more preferably greater than or equal to 0.4 mol/L and even more preferably greater than or equal to 0.5 mol/L.

For example, the catholyte includes at least one organosulfur species participating in the capacity of the cathode in a concentration such that the concentration of the reactive function —SH or —SM is between 0.1 and 2 mol/L, preferably between 0.2 and 1.2 mol/L, more preferably between 0.4 and 1 mol/L and even more preferably between 0.5 and 0.9 mol/L; with M selected from a sodium, a lithium, or a quaternary ammonium, sulfonium or phosphonium.

As shall be shown in the examples, the inventors determined particularly advantageous ratios between the amount of organic sulfur and the amount of mineral sulfur in the cathode/catholyte assembly or the total amount of sulfur in the cathode/catholyte assembly.

The amount of mineral sulfur may notably correspond to the sulfur in elemental form present in the cathode and more particularly in the composite material. However, the mineral sulfur may also include sulfur in elemental form which has been added to the catholyte.

The amount of organic sulfur may correspond more particularly to the amount of sulfur present in the organosulfur species participating in the capacity of the cathode. The sulfur present in the organosulfur species participating in the capacity of the cathode is that found in the cathode but may also include that which may be present in the cathode and/or the separator.

The total amount of sulfur corresponds to the mineral sulfur and also to the sulfur present in the organosulfur species participating in the capacity of the cathode.

The mineral sulfur and the organic sulfur present in the organosulfur species participating in the capacity of the cathode may be quantified, for example, by: high-performance liquid chromatography, X-ray crystallography, X-ray absorption spectrometry, Raman spectroscopy, infrared spectroscopy, UV-Vis spectroscopy, differential scanning calorimetry or mass spectrometry (e.g. ICP-MS or ICP-MS-MS).

Advantageously, the mineral sulfur/organic sulfur mole ratio is between 0.05 and 10, preferably between 0.1 and 7. Even more preferably, the mineral sulfur/organic sulfur ratio is substantially equal to 5. In particular, the mole ratio of mineral sulfur/sulfur present in the organosulfur species participating in the capacity of the cathode is between 0.05 and 10, preferably between 0.1 and 7. Even more preferably, the mole ratio of mineral sulfur/sulfur present in the organosulfur species participating in the capacity of the cathode is substantially equal to 5.

### The Organosulfur Species

The organosulfur species is preferably selected from: an organic disulfide, an organic polysulfide, a thiol (i.e. mercaptan), a polythiol, a thiolate (i.e. mercaptide) or a polythiolate. In addition, it may be in the form of an oligomer or a polymer.

These compounds may contain one or more S—S bonds which can be broken during the discharging cycle of a lithium-sulfur battery and reformed during the charging cycle. Similarly, the thiol and thiolate functions can entail, during the charging cycle, the formation of S—S bonds.

The organosulfur species may in particular correspond to a compound according to formula I:

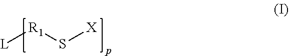

in which:
X=—H, -M or -A;
M is selected from a sodium, a lithium, or a quaternary ammonium, sulfonium or phosphonium;
A=—Sₙ—R1′-L′;
the groups R₁ and R₁′ are identical or different and represent a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms;
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to R₁′ or to L′ and if L′ includes a free bond, then it makes it possible to connect L′ to R₁ or to L;
the group R₅ represents a group selected from: a hydrogen, —(C₁-C₁₂)alkyl, —(C₂-C₁₂)alkenyl or (C₂-C₁₂)alkynyl;
n is an integer between 1 and 5, limits included; and
p is an integer between 1 and 10.

For example, when p is greater than or equal to 2, the organosulfur species participating in the capacity of the cathode may correspond to the following compounds:

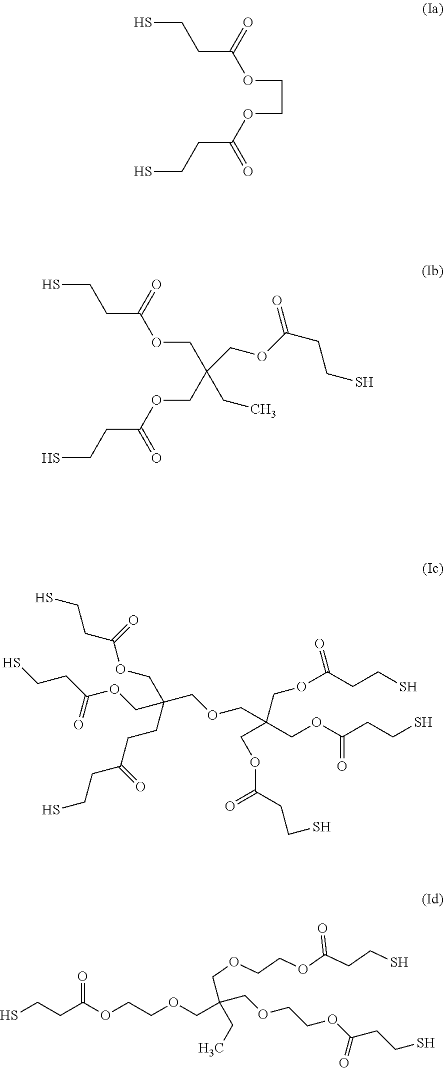 [SMILES: O=C(CCS)OCCOC(=O)CCS ; CCC(COC(=O)CCS)(COC(=O)CCS)COC(=O)CCS ; O=C(CCS)CCC(COCC(COC(=O)CCS)(COC(=O)CCS)COC(=O)CCS)(COC(=O)CCS)COC(=O)CCS ; CCC(COCCOC(=O)CCS)(COCCOC(=O)CCS)COCCOC(=O)CCS]

The syntheses of these compounds are known and they are commercially available, for example under the name Thiocure® (trade name). In this context, the organosulfur species participating in the capacity of the cathode may be selected more particularly from: Thiocure® GDMP (Ia), Thiocure® TMPMP (Ib), Thiocure® Di-PETMP (Ic), Thiocure® ETTMP (Id), Thiocure® PETMP, Thiocure® GDMA, Thiocure® TMPMA, Thiocure® PETMA and Thiocure® TEMPIC (trade names).

When p is equal to 1, the organosulfur species may in particular correspond to a compound according to formula I′:

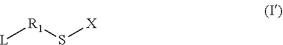

in which:
X=—H, -M or -A;
M is selected from a sodium, a lithium, or a quaternary ammonium, sulfonium or phosphonium;
A=—Sₙ—R₁′-L′;
the groups R₁ and R₁′ are identical or different and represent a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms;
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to R₁′ or to L′ and if L′ includes a free bond, then it makes it possible to connect L′ to R₁ or to L;
the group R₅ represents a group selected from: a hydrogen, —(C₁-C₁₂)alkyl, —(C₂-C₁₂)alkenyl or (C₂-C₁₂)alkynyl; and
n is an integer between 1 and 5, limits included.

In particular, the organosulfur species may correspond to an organic polysulfide.

When the organosulfur species corresponds to an organic polysulfide such as a disulfide, then it may correspond to a compound according to formula II.

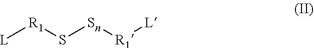

in which:
the groups R₁ and R₁′ are identical or different and represent a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms;
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to R₁′ or to L′ and if L′ includes a free bond, then it makes it possible to connect L′ to R₁ or to L;
the group R₅ represents a group selected from: a hydrogen, —(C₁-C₁₂)alkyl, —(C₂-C₁₂)alkenyl or (C₂-C₁₂)alkynyl; and
n is an integer between 1 and 5, limits included.

In particular, the organosulfur species may correspond to an organic disulfide and may thus comprise a disulfide group.

In this context, an organosulfur species of disulfide type participating in the capacity of the cathode may correspond to a compound according to formula III.

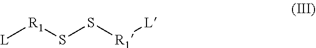

in which:
the groups R₁ and R₁′ are identical or different and represent a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms;
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COOR₅, —CSSR₅ and —OR₅; with, if L includes a free bond, then it makes it possible to connect to L to R₁′ or to L′ and if L′ includes a free bond, then it makes it possible to connect L′ to R₁ or to L; and
the group R₅ represents a group selected from: a hydrogen, —(C₁-C₁₂)alkyl, —(C₂-C₁₂)alkenyl or (C₂-C₁₂)alkynyl.

In particular, the groups R₁ and R₁′ may represent, respectively, R₂—R₄—R₃— and —R₂′—R₄′—R₃′— in which:
the groups R₂, R₃, R₂ and R₃′ are identical or different and represent a group selected from: a single bond, a double bond, a triple bond, —(C₁-C₁₂)alkyl-, —(C₂-C₁₂)alkenyl-, —(C₂-C₁₂)alkynyl-, -aryl-, -cycloalkyl-, which may be substituted or unsubstituted;
the groups R₄ and R₄′ are identical or different and represent a group selected from: a single bond, —NHR₅—, —SO₂—, —S—, —COO—, —CO—, —COS—, —CSS— and —O—;
the group R₅ represents a group selected from: a hydrogen, —(C₁-C₁₂)alkyl, —(C₂-C₁₂)alkenyl or (C₂-C₁₂)alkynyl.

Thus, preferably, the organosulfur species participating in the capacity of the cathode may correspond to symmetrical disulfide compounds bearing an alkyl chain: dimethyl disulfide (compound IIIc), diethyl disulfide (DEDS), dipropyl disulfide (DPDS), dibutyl disulfide (DBDS), dipentyl disulfide (or diamyl disulfide), dihexyl disulfide.

Some of these compounds and also disulfides obtained from the oxidation of thioglycolic acid esters, such as compounds IIIc and IIId, are illustrated below:

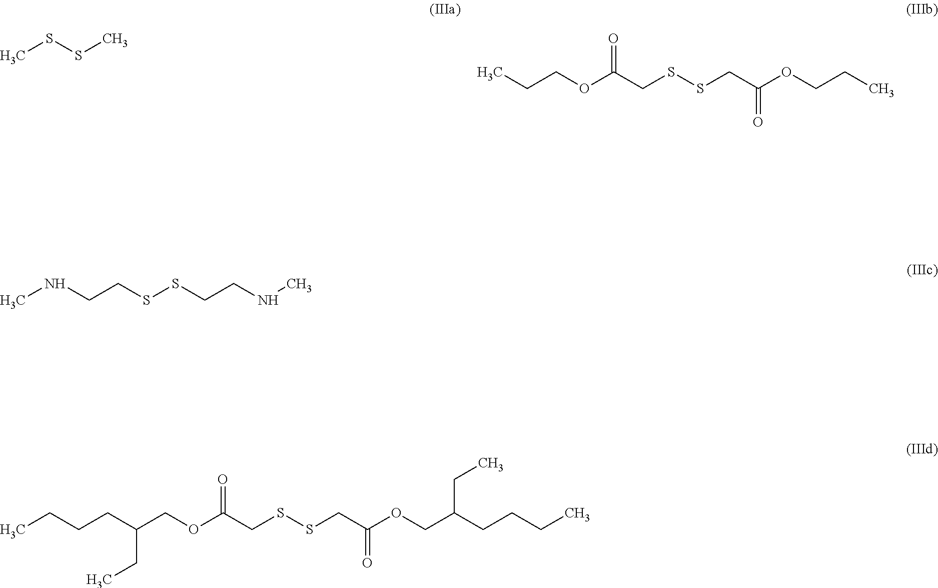

The organosulfur species participating in the capacity of the cathode may also correspond to asymmetrical or mixed disulfides bearing an alkyl chain, such as ethyl methyl disulfide (IIIe).

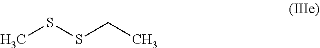

In the context of the invention, mixtures of asymmetrical and symmetrical disulfides, of different alkyl or aryl chains, may be used. Thus, the organosulfur species participating in the capacity of the cathode may correspond to a mixture of organosulfur species.

For example, DSOs (disulfide oils) are mixtures of disulfides originating, for example, from gas or oil extraction fields and may be used in the case of the present invention. DTDDS (di-tert-dodecyl disulfide, IIIf) is a mixture of disulfides, the majority of which consists of disulfides bearing carbon-based chains of 12 carbons.

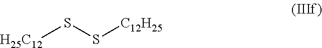

The organosulfur species participating in the capacity of the cathode may also correspond to compounds of disulfide type obtained from the oxidation of dithiols:

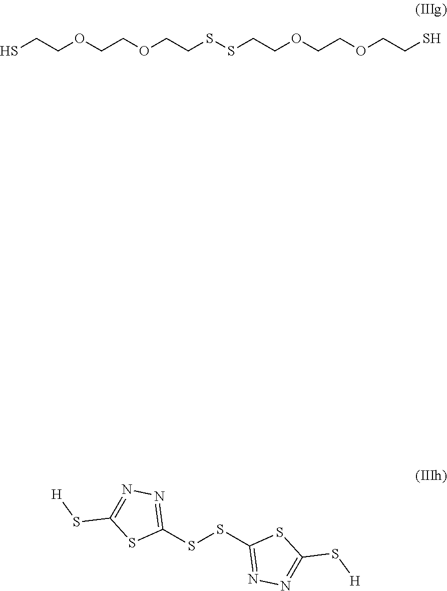 [SMILES: SCCOCCOCCSSCCOCCOCCS ; Sc1nnc(SSc2nnc(S)s2)s1]

The organosulfur species participating in the capacity of the cathode may also correspond to a molecule containing several disulfide units. It may thus be in the form of linear molecules such as the adduct of two DMDO molecules, or cyclic molecules, for instance the following compounds:

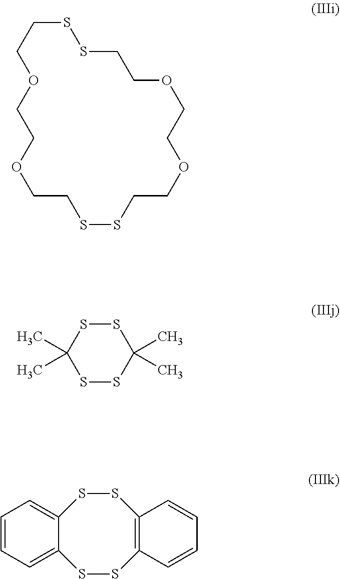

In particular, for compounds (IIIi), (IIIj) and (IIIk), L includes a bond for connecting L to R₁′ or to L′.

The organosulfur species participating in the capacity of the cathode may also correspond to rings and more particularly may comprise aromatic rings directly bonded to the S—S bond.

Thus, according to one embodiment, the organosulfur species participating in the capacity of the cathode may correspond to a compound according to formula IV.

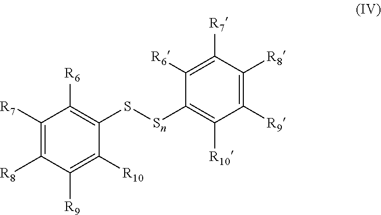

in which:
the groups R₆, R₇, R₈, R₉, R₁₀, R₆′, R₇′, R₈′, R₉′ and R₁₀′ are identical or different and represent a group selected from: a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅;
the group R₅ represents a group selected from: a hydrogen, —(C₁-C₁₂)alkyl, —(C₂-C₁₂)alkenyl or (C₂-C₁₂)alkynyl; and
n is an integer between 1 and 5, limits included.

As shall be presented in the examples, in this context, the organosulfur species participating in the capacity of the cathode may correspond to the following compounds:

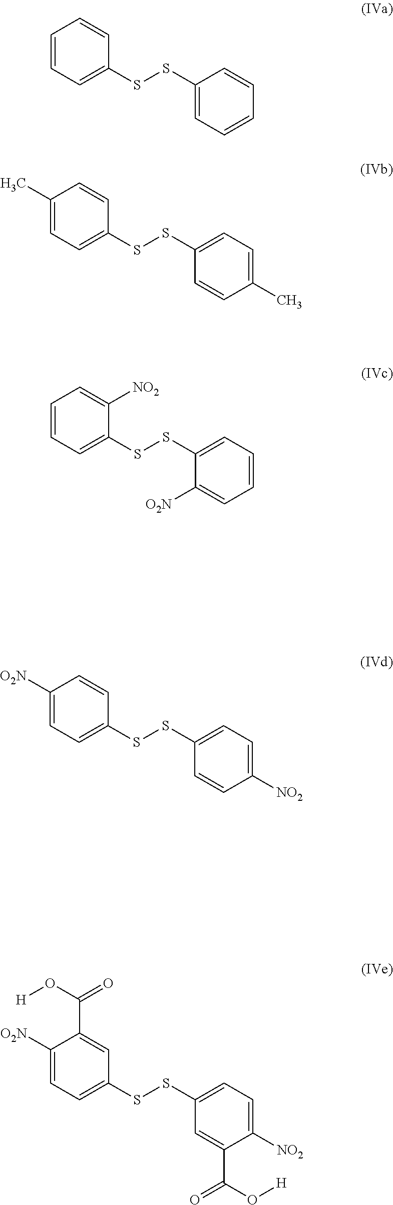

The organosulfur species participating in the capacity of the cathode may also comprise one or two carbonyl or thiocarbonyl groups directly bonded to a disulfide (S—S) bond.

Thus, according to one embodiment, the organosulfur species participating in the capacity of the cathode may correspond to a compound according to formula V.

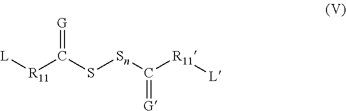

in which:
the groups R₁₁ and R₁₁′ are identical or different and represent a branched or linear, saturated or unsaturated group composed of 1 to 19 carbons, for example of alkyl, aryl, heteroaryl, cycloalkyl, arylalkyl or alkylaryl type and which may contain one or more heteroatoms;
the groups G and G′ are identical or different and represent an atom selected from oxygen and sulfur;
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to R₁₁′ or to L′ and if L′ includes a free bond, then it makes it possible to connect L′ to R₁₁ or to L;
the group R₅ represents a group selected from: a hydrogen, —(C₁-C₁₂)alkyl, —(C₂-C₁₂)alkenyl or (C₂-C₁₂)alkynyl; and
n is an integer between 1 and 5, limits included.

In particular, the groups R₁₁ and R₁₁′ may represent, respectively, R₂—R₄—R₃— and —R₂′—R₄′—R₃′— in which:
the groups R₂, R₃, R₂ and R₃′ are identical or different and represent a group selected from: a single bond, a double bond, a triple bond, —(C₁-C₁₂)alkyl-, —(C₂-C₁₂)alkenyl-, —(C₂-C₁₂)alkynyl-, -aryl-, -cycloalkyl-, which may be substituted or unsubstituted;
the groups R₄ and R₄′ are identical or different and represent a group selected from: a single bond, —NHR₅—, —SO₂—, —S—, —COO—, —CO—, —COS—, —CSS— and —O—;
the group R₅ represents a group selected from: a hydrogen, —(C₁-C₁₂)alkyl, —(C₂-C₁₂)alkenyl or (C₂-C₁₂)alkynyl.

As shall be presented in the examples, in this context, the organosulfur species participating in the capacity of the cathode may correspond to the following compounds:

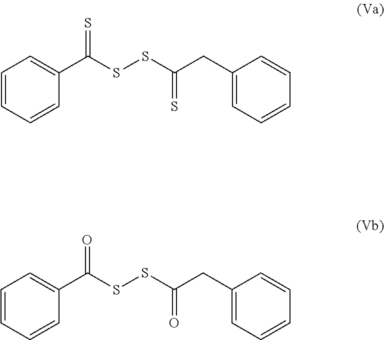 [SMILES: S=C(Cc1ccccc1)SSC(=S)c1ccccc1 ; O=C(Cc1ccccc1)SSC(=O)c1ccccc1]

As has been presented previously, many organosulfur species participating in the capacity of the cathode and preferred in the context of the invention are of disulfide type. However, certain organosulfur species molecules participating in the capacity of the cathode and preferred in the context of the invention may also be of trisulfide or polysulfide type.

An organosulfur species of polysulfide type participating in the capacity of the cathode may correspond to a compound according to formula II′.

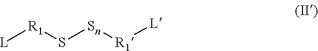

in which:
the groups R₁ and R₁′ are identical or different and represent a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms;
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COOR₅, —CSSR₅ and —OR₅; with, if L includes a free bond, then it makes it possible to connect to L to R₁′ or to L′ and if L′ includes a free bond, then it makes it possible to connect L′ to R₁ or to L;
the group R₅ represents a group selected from: a hydrogen, —(C₁-C₁₂)alkyl, —(C₂-C₁₂)alkenyl or (C₂-C₁₂)alkynyl; and
n is an integer between 2 and 5, limits included.

In particular, the groups R₁ and R₁′ may represent, respectively, groups —R₂—R₄—R₃— and —R₂′—R₄′—R₃′—

in which:
the groups R₂, R₃, R₂ and R₃′ are identical or different and represent a group selected from: a single bond, a double bond, a triple bond, —(C₁-C₁₂)alkyl-, —(C₂-C₁₂)alkenyl-, —(C₂-C₁.2)alkynyl-, -aryl-, -cycloalkyl-, which may be substituted or unsubstituted;
the groups R₄ and R₄′ are identical or different and represent a group selected from: a single bond, —NHR₅—, —SO₂—, —S—, —COO—, —CO—, —COS—, —CSS— and —O—;
the group R₅ represents a group selected from: a hydrogen, —(C₁-C₁₂)alkyl, —(C₂-C₁₂)alkenyl or (C₂-C₁₂)alkynyl.

Thus, preferably, the organosulfur species participating in the capacity of the cathode may correspond to the compounds of formula II′a:

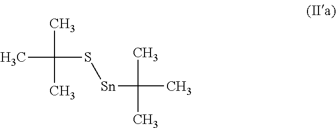

in which n is an integer between 2 and 5, limits included.

The organosulfur species participating in the capacity of the cathode may also correspond to a mixture of organosulfur species. In the present case in the context of polysulfides, the organosulfur species may correspond to a mixture of compounds according to formula II′a, said compounds being identical and having various values of n, in which n has an average value of between 2 and 5.

Alternatively, the organosulfur species of polysulfide type participating in the capacity of the cathode may correspond to a compound according to formula VI-1:

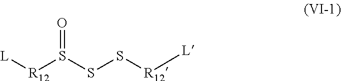

in which
the groups R₁₂ and R₁₂′ are identical or different and represent a branched or linear, saturated or unsaturated group composed of 1 to 20 carbons, for example of alkyl, aryl, heteroaryl, cycloalkyl, arylalkyl or alkylaryl type and which may contain one or more heteroatoms; and
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to R₁₂′ or to L′ and if L′ includes a free bond, then it makes it possible to connect L′ to R₁₂ or to L; and
the group R₅ represents a group selected from: a hydrogen, —(C₁-C₁₂)alkyl, —(C₂-C₁₂)alkenyl or (C₂-C₁₂)alkynyl.

In particular, the groups R₁₂ and R₁₂′ may represent, respectively, groups —R₂—R₄—R₃— and —R₂′—R₄′—R₃′—

in which:
the groups R₂, R₃, R₂ and R₃′ are identical or different and represent a group selected from: a single bond, a double bond, a triple bond, —(C₁-C₁₂)alkyl-, —(C₂-C₁₂)alkenyl-, —(C₂-C₁₂)alkynyl-, -aryl-, -cycloalkyl-, which may be substituted or unsubstituted;
the groups R₄ and R₄′ are identical or different and represent a group selected from: a single bond, —NHR₅—, —SO₂—, —S—, —COO—, —CO—, —COS—, —CSS— and —O—; and
the group R₅ represents a group selected from: a hydrogen, —(C₁-C₁₂)alkyl, —(C₂-C₁₂)alkenyl or (C₂-C₁₂)alkynyl.

As shall be presented in the examples, in this context, the organosulfur species participating in the capacity of the cathode may correspond to the following compounds:

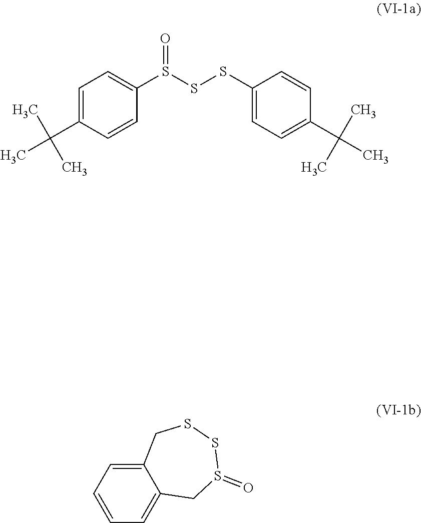 [SMILES: CC(C)(C)c1ccc(SSS(=O)c2ccc(C(C)(C)C)cc2)cc1 ; O=S1Cc2ccccc2CSS1]

Alternatively, the organosulfur species of polysulfide type participating in the capacity of the cathode may correspond to a compound according to formula VI-2:

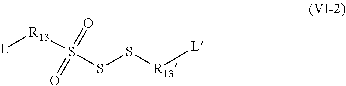

in which
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to R₁₂′ or to L′ and if L′ includes a free bond, then it makes it possible to connect L′ to R₁₂ or to L;
the group R₅ represents a group selected from: a hydrogen, —(C₁-C₁₂)alkyl, —(C₂-C₁₂)alkenyl or (C₂-C₁₂)alkynyl; and
the groups R₁₃ and R₁₃′ are identical or different and represent a branched or linear, saturated or unsaturated group composed of 1 to 20 carbons, for example of alkyl, aryl, heteroaryl, cycloalkyl, arylalkyl or alkylaryl type and which may contain one or more heteroatoms.

In particular, the groups R₁₃ and R₁₃′ may represent, respectively, groups —R₂—R₄—R₃— and —R₂′—R₄′—R₃′—in which:
the groups R₂, R₃, R₂ and R₃′ are identical or different and represent a group selected from: a single bond, a double bond, a triple bond, —(C₁-C₁₂)alkyl-, —(C₂-C₁₂)alkenyl-, —(C₂-C₁.2)alkynyl-, -aryl-, -cycloalkyl-, which may be substituted or unsubstituted;
the groups R₄ and R₄′ are identical or different and represent a group selected from: a single bond, —NHR₅—, —SO₂—, —S—, —COO—, —CO—, —COS—, —CSS— and —O—; and
the group R₅ represents a group selected from: a hydrogen, —(C₁-C₁₂)alkyl, —(C₂-C₁₂)alkenyl or (C₂-C₁₂)alkynyl.

As shall be presented in the examples, in this context, the organosulfur species participating in the capacity of the cathode may correspond to the following compounds:

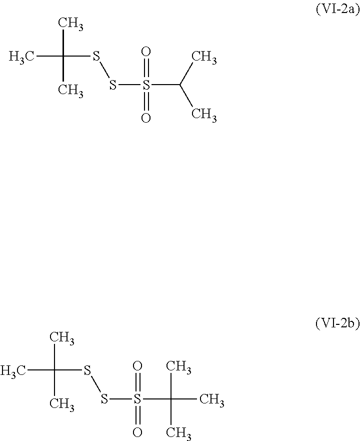

In particular, the organosulfur species may comprise at least one thiol group; for example, it comprises one thiol group or two thiol groups.

An organosulfur species of thiol type participating in the capacity of the cathode may correspond to a compound according to formula VII

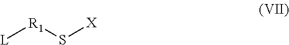

in which:
X is selected from a hydrogen and the group M;
M is selected from a sodium, a lithium, or a quaternary ammonium, sulfonium or phosphonium;
the group R₁ represents a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms;
the group L represents a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to R₁; and
the group R₅ represents a group selected from: a hydrogen, —(C₁-C₁₂)alkyl, —(C₂-C₁₂)alkenyl or (C₂-C₁₂)alkynyl.

In particular, the group R₁ may represent the groups —R₂—R₄—R₃— in which:
the groups R₂ and R₃ are identical or different and represent a group selected from: a single bond, a double bond, a triple bond, —(C₁-C₁₂)alkyl-, —(C₂-C₁₂)alkenyl-, —(C₂-C₁₂)alkynyl-, -aryl-, -cycloalkyl-, which may be substituted or unsubstituted;
the group R₄ represents a group selected from: a single bond, —NHR₅—, —SO₂—, —S—, —COO—, —CO—, —COS—, —CSS— and —O—;
the group R₅ represents a group selected from: a hydrogen, —(C₁-C₁₂)alkyl, —(C₂-C₁₂)alkenyl or (C₂-C₁₂)alkynyl.

Preferably, X is a hydrogen.

The organosulfur species participating in the capacity of the cathode may then be a molecule selected from: methyl mercaptan, ethyl mercaptan, isopropyl mercaptan, tert-butyl mercaptan, n-octyl mercaptan, n-dodecyl mercaptan, tert-nonyl mercaptan, tert-dodecyl mercaptan, thioglycolic acid or 2-ethylhexyl thioglycolate (2-EHTG).

In particular, the organosulfur species may comprise at least two thiol groups; for example, the organosulfur species may comprise two thiol groups.

As shall be presented in the examples, in this context, the organosulfur species of dithiol type participating in the capacity of the cathode may be a linear molecule and may correspond to the following compounds:

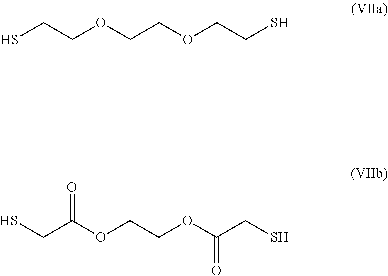 [SMILES: SCCOCCOCCS ; O=C(CS)OCCOC(=O)CS]

The organosulfur species of thiol type participating in the capacity of the cathode may also be a molecule including one or more cycloalkyl, aryl or heteroaryl rings, with, for example, the following compounds:

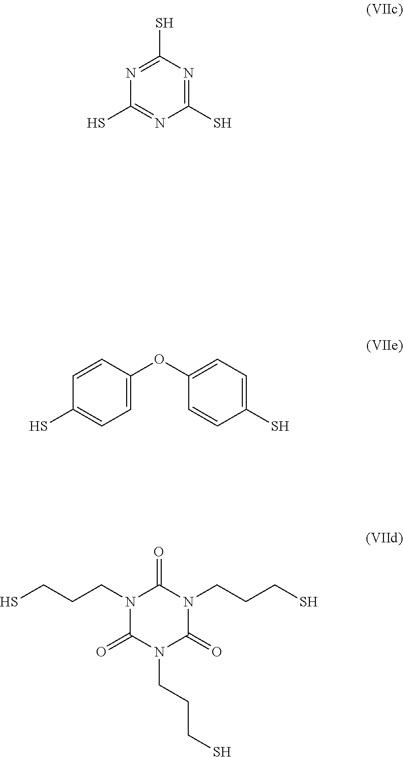 [SMILES: Sc1nc(S)nc(S)n1 ; Sc1ccc(Oc2ccc(S)cc2)cc1 ; O=c1n(CCCS)c(=O)n(CCCS)c(=O)n1CCCS]

Advantageously, the organosulfur species participating in the capacity of the cathode may be selected from: 1,8-dimercapto-3,6-dioxaoctane (DMDO—compound VIIa), 2,5-dimercapto-1,3,4-thiadiazole (DMTD) or bis-DMTD.

In particular, an organosulfur species of thiol type participating in the capacity of the cathode may correspond to a compound according to formula VIII

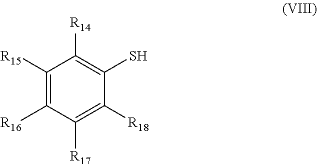

in which:
the groups R₁₄, R₁₅, R₁₆, R₁₇ and R₁₈ are identical or different and represent a group selected from: a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COOR₅, —CSSR₅ and —OR₅; and
the group R₅ represents a group selected from: a hydrogen, —(C₁-C₁₂)alkyl, —(C₂-C₁₂)alkenyl or (C₂-C₁₂)alkynyl.

The organosulfur species participating in the capacity of the cathode may be a cyclic molecule and may correspond to the following compounds:

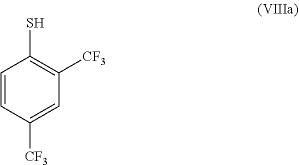 [SMILES: FC(F)(F)c1ccc(S)c(C(F)(F)F)c1]

In particular, the organosulfur species may comprise at least one group of thioacid type.

An organosulfur species of thioacid type participating in the capacity of the cathode may correspond to a compound according to formula IX

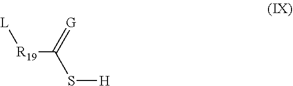

in which:
G is an atom selected from: oxygen and sulfur;
the group Rig represents a branched or linear, saturated or unsaturated group composed of 1 to 19 carbons, for example of alkyl, aryl, heteroaryl, cycloalkyl, arylalkyl or alkylaryl type and which may contain one or more heteroatoms;
the group L represents a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to Rig;
the group R₅ represents a group selected from: a hydrogen, —(C₁-C₁₂)alkyl, —(C₂-C₁₂)alkenyl or (C₂-C₁₂)alkynyl.

In particular, the group Rig may represent the groups —R₂—R₄—R₃— in which:
the groups R₂ and R₃ are identical or different and represent a group selected from: a single bond, a double bond, a triple bond, —(C₁-C₁₂)alkyl-, —(C₂-C₁₂)alkenyl-, —(C₂-C₁₂)alkynyl-, -aryl-, -cycloalkyl-, which may be substituted or unsubstituted;
the group R₄ represents a group selected from: a single bond, —NHR₅—, —SO₂—, —S—, —COO—, —CO—, —COS—, —CSS— and —O—; and
the group R₅ represents a group selected from: a hydrogen, —(C₁-C₁₂)alkyl, —(C₂-C₁₂)alkenyl or (C₂-C₁₂)alkynyl.

For example, the organosulfur species participating in the capacity of the cathode may be thioacetic acid.

As has been mentioned, the organosulfur species participating in the capacity of the cathode according to the invention may correspond to an oligomer or to a polymer. The oligomer and the polymer may include disulfide, trisulfide or polysulfide functions and also thiol or thiolate functions. Thus, it is possible to describe these compounds as polysulfides, poly(polysulfides), polythiols or polythiolates. In general, the organosulfur species may correspond to an oligomer or polymer bearing alkyl-chain or aryl-chain monomers, which may include heteroatoms, being linear, cyclic or three-dimensional (i.e. dendrimers).

In particular, the organosulfur species advantageously includes a repetition of the unit according to formula I and it may correspond to an oligomer or to a polymer which may be formed from monomers according to formula I.

Thus, the organosulfur species may correspond, for example, to a compound of formula X:

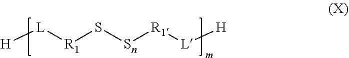

in which:
the groups R₁ and R₁′ are identical or different and represent a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms;
the groups L and L′ are identical or different and represent a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to R₁′ or to L′ and if L′ includes a free bond, then it makes it possible to connect L′ to R₁ or to L; and
the group R₅ represents a group selected from: a hydrogen, —(C₁-C₁₂)alkyl, —(C₂-C₁₂)alkenyl or (C₂-C₁₂)alkynyl; and
n is an integer between 1 and 5, limits included; and
m is an integer between 2 and 1000, limits included.

In particular, the groups R₁ and R₁′ may represent, respectively, —R₂—R₄—R₃— and —R₂′—R₄′—R₃′— in which:
the groups R₂, R₃, R₂′ and R₃′ are identical or different and represent a group selected from: a single bond, a double bond, a triple bond, —(C₁-C₁₂)alkyl-, —(C₂-C₁₂)alkenyl-, —(C₂-C₁₂)alkynyl-, -aryl-, -cycloalkyl-, which may be substituted or unsubstituted;
the groups R₄ and R₄′ are identical or different and represent a group selected from: a single bond, —NHR₅—, —SO₂—, —S—, —COO—, —CO—, —COS—, —CSS— and —O—; and
the group R₅ represents a group selected from: a hydrogen, —(C₁-C₁₂)alkyl, —(C₂-C₁₂)alkenyl or (C₂-C₁₂)alkynyl.

Alternatively, the organosulfur species may correspond, for example, to a compound of formula X′:

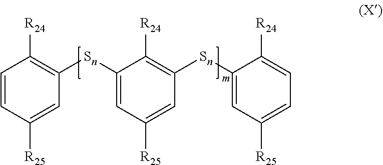

in which:
the groups R₂₄ and R₂₅ are identical or different and represent a group selected from: a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; and
the group R₅ represents a group selected from: a hydrogen, —(C₁-C₁₂)alkyl, —(C₂-C₁₂)alkenyl or (C₂-C₁₂)alkynyl;
n is an integer between 1 and 5, limits included; and
m is an integer between 1 and 1000, limits included.

For example, the organosulfur species participating in the capacity of the cathode may correspond to the following compound:

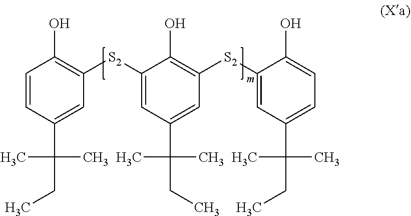

The polymeric organosulfur species according to the invention may be formed from organosulfur species including two thiol functions. For example, the polymeric organosulfur species participating in the capacity of the cathode may correspond to polymers formed, for example, at least partly by compounds according to formula VII in which L is an —SH function. The organosulfur species participating in the capacity of the cathode may correspond to a compound according to formula XI:

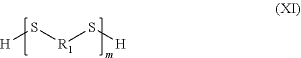

in which the group R₁ represents a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms; and m is an integer between 2 and 1000, limits included.

The organosulfur species may correspond, for example, to the following compounds:

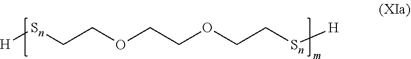

in which n is an integer between 1 and 5, and m is between 2 and 1000, limits included

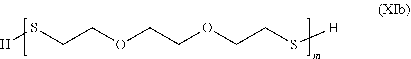

in which m is between 2 and 1000

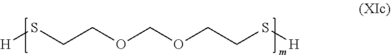

in which m is between 2 and 1000

In particular, the group R₁ may represent a substituted or unsubstituted aryl or heteroaryl group.

More particularly, in the case where R₁ is a substituted aryl, then the organosulfur species may correspond to a compound according to formula XII:

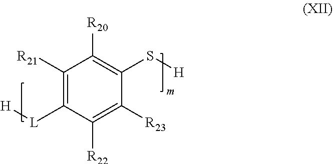

in which:
the group L represents a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅; with, if L includes a free bond, then it makes it possible to connect to L to the terminal sulfur; and
the groups R₂₀, R₂₁, R₂₂ and R₂₃ are identical or different and represent a group selected from: a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COSR₅, —CSSR₅ and —OR₅;
the group R₅ represents a group selected from: a hydrogen, —(C₁-C₁₂)alkyl, —(C₂-C₁₂)alkenyl or (C₂-C₁₂)alkynyl; and
m is an integer between 2 and 1000, limits included.

The organosulfur species participating in the capacity of the cathode may then correspond to the following cyclic compounds:

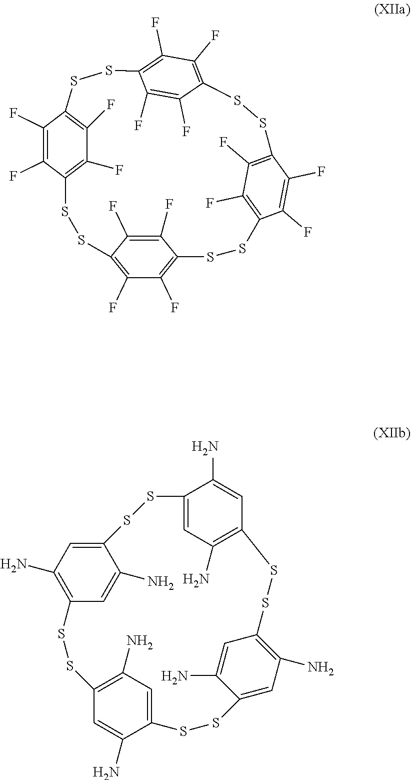 [SMILES: Fc1c(F)c2c(F)c(F)c1SSc1c(F)c(F)c(c(F)c1F)SSc1c(F)c(F)c(c(F)c1F)SSc1c(F)c(F)c(c(F)c1F)SS2 ; Nc1cc2c(N)cc1SSc1cc(N)c(cc1N)SSc1cc(N)c(cc1N)SSc1cc(N)c(cc1N)SS2]

The polymeric organosulfur species according to the invention may also correspond to an oligomer or a polymer formed from compounds according to formula I to form a molecule in which the group L is bonded to the group R₁ of another molecule, directly or via a substituent on the group R₁.

In this context, the polymeric organosulfur species according to the invention may correspond to the compounds according to formula XIII:

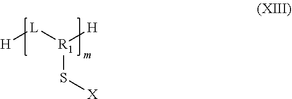

in which:
—X=—H, -M, M being selected from a sodium, a lithium, or a quaternary ammonium, sulfonium or phosphonium;
the group R₁ represents a branched or linear or cyclic, saturated or unsaturated group composed of 1 to 20 carbons, for example of alkyl, aryl, heteroaryl, cycloalkyl, arylalkyl or alkylaryl type and which may contain one or more heteroatoms;
the group L represents a group selected from: a single bond, a double bond, a triple bond, —NHR₅—, —SO₂—, —S—, —COO—, —CO—, —COS—, —CSS—, —O—, —CONR₅—, a hydrogen, —(C₁-C₁₂)alkyl, —(C₂-C₁₂)alkenyl, —(C₂-C₁₂)alkynyl, —F, —CF₃, —NH₂, —NO₂, —SO₂H, —SH, —COOR₅, —COR₅, —COOR₅, —CSSR₅ and —OR₅; with, if L includes a free bond, then it makes it possible to connect to L to R₁′ or to L′ and if L′ includes a free bond, then it makes it possible to connect L′ to R₁ or to L; and
the group R₅ represents a group selected from: a hydrogen, —(C₁-C₁₂)alkyl, —(C₂-C₁₂)alkenyl or (C₂-C₁₂)alkynyl; and
m is an integer between 2 and 1000, limits included.

The organosulfur species participating in the capacity of the cathode may thus correspond to the following linear compounds:

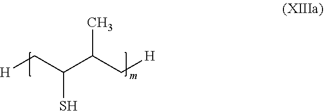

in which m is an integer between 2 and 1000, limits included
or:

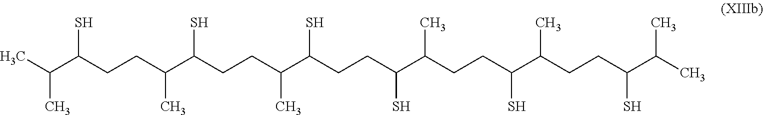 [SMILES: CC(C)C(S)CCC(C)C(S)CCC(C)C(S)CCC(S)C(C)CCC(S)C(C)CCC(S)C(C)C]

In particular, the group R₁ may represent an aryl or heteroaryl group. In the case where R₁ is a substituted aryl or a substituted heteroaryl, then the organosulfur species may correspond to the following compound:

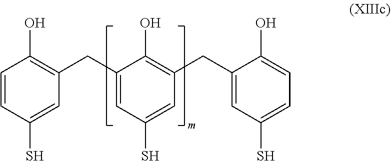

in which m is an integer between 2 and 1000, limits included.

The catholyte may contain a mixture of organosulfur species participating in the capacity of the cathode.

When the organosulfur species according to the invention are in the thiol form, it should be understood that the invention also covers these organosulfur species in the form of thiolates. The counterion is then advantageously selected from: a sodium, a lithium, or a quaternary ammonium, sulfonium or phosphonium.

When the organosulfur species participating in the capacity of the cathode is a polymer, it may then also act as a polymeric binder.

Such an organosulfur species also acting as a polymeric binder may be selected, for example, from: compound XIa, compound XIb, compound XIc, polyphenylene disulfide copolymers, and any other polymer containing disulfide —S—S— or polysulfide —Sₙ— species in the main polymer chain and —SH groups in the functionalities.

In this context, a formulation of the organosulfur species may be in liquid form with a very low viscosity at room temperature or may have a viscosity of greater than 20 000 cPs forming a viscous gel or may be in solid form if the compound is mainly formed from polymer.

Alternatively, the organosulfur species participating in the capacity of the cathode may be associated with the separator.

### Catholyte Additives

The catholyte may also comprise sulfur in elemental form. In this case, the sulfur in elemental form is preferably in a mixture with a compound of thiolate type.

In particular, the catholyte includes sulfur in elemental form in a (sulfur in elemental form)/(compound of thiolate type) mole ratio of between 1 and 10.

The concentration of sulfur in elemental form in the catholyte may be, for example, greater than or equal to 0.05 mol/L, preferably greater than or equal to 0.1 mol/L, more preferably greater than or equal to 0.2 mol/L. The sulfur in elemental form is generally present in a concentration of less than 5 mol/L.

The concentration of thiolate, for its part, is generally less than or equal to 0.5 mol/L. It may be, for example, greater than or equal to 0.05 mol/L, preferably greater than or equal to 0.1 mol/L, more preferably greater than or equal to 0.2 mol/L.

Various sources of native sulfur are commercially available. The particle size of the sulfur powder may vary within wide ranges. The sulfur may be used as is or the sulfur may be purified beforehand according to different techniques, such as refining, sublimation or precipitation. The sulfur or more generally the sulfur-based material may also be subjected to a preliminary step of milling and/or screening in order to reduce the size of the particles and to narrow their distribution.

The catholyte makes it possible to transport the alkali metal ions from one electrode to the other. The catholyte may thus be a liquid catholyte including one or more alkali metal salts, such as a lithium salt, dissolved in an organic solvent.

Thus, the catholyte also comprises one or more alkali metal salts such as ATFSI, AFSI, ANO₃, ATDI, ACF₃SO₃, AFO₃, ABO₂, AClO₄, APF₆, AClO₄, A₂B₁₂F₁₂, ABC₄O₈, ABF₄, AF, mineral polysulfide salts A_{z}Sₓ, or mixtures thereof,

with A selected from Li, Na, K, Rb and Cs,
x an integer greater than or equal to 2,
z an integer greater than or equal to 2.

The catholyte may thus comprise a lithium salt preferably selected from: lithium fluorate (LiFO₃), lithium metaborate (LiBO₂), lithium perchlorate (LiClO₄), lithium nitrate (LiNO₃), lithium bis(oxalato)borate (LiBOB or LiB(C₂O₄)₂), lithium trifluoromethanesulfonate (LiTF), lithium (bis)trifluoromethanesulfonate imide (LiTFSI), lithium 2-trifluoromethyl-4,5-dicyanoimidazole (LiTDI), lithium bis(fluorosulfonyl)imide (LiFSI), lithium hexafluorophosphate (LiPF₆), lithium perchlorate (LiClO₄), lithium trifluoromethylsulfonate (CF₃SO₃Li), lithium trifluoroacetate (CF₃COOLi), dilithium dodecafluorododecaborate (Li₂B₁₂F₁₂), lithium bis(oxalate)borate (LiBC₄O₈) and lithium tetrafluoroborate (LiBF₄), mineral polysulfides of Li, S_{y}Li, with y an integer greater than or equal to 2, and mixtures thereof.

Even more preferably, the catholyte also comprises one or more lithium salts, such as LiTFSi, LiFSi, LiTDI, LiNO₃, LiCF₃SO₃, mineral polysulfides of Li, S_{y}Li, with y an integer greater than or equal to 2, and mixtures thereof.

Even more preferably, the catholyte includes LiTFSI or LiFSI.

The concentration of the alkali metal salt(s) in the catholyte is preferably between about 0.1 to 2 mol/L, preferably from about 0.2 to 1 mol/L and more preferably from about 0.25 to 0.75 mol/L.

The catholyte of the battery according to the invention is nonaqueous, i.e. it thus does not comprise any water or aqueous solvents. Thus, the catholyte according to the invention preferably includes less than 50 ppm of water and more preferably less than 25 ppm of water.

The catholyte may comprise, for example, a polymeric binder, said polymeric binder not participating in the capacity of the cathode.

The polymeric binder may have a molar mass of greater than 10 000 g·mol⁻¹, preferably greater than 50 000 g·mol⁻¹ and more preferably greater than 100 000 g·mol⁻¹. As a function of its molar mass, the polymeric binder may be capable of forming a liquid, gelled or solid catholyte.

A solid catholyte is an electrolyte that is solid at room temperature, preferably comprising a mixture of polymers and of lithium salts. This type of catholyte may be used without a separator since it offers physical separation of the positive and negative electrodes. However, the functioning of the battery must be conducted at a temperature above room temperature, to allow the molten state of the catholyte and sufficient movement of the lithium ions (T>65° C. for POE).

A gelled catholyte is a catholyte in which a polymer is mixed with a lithium salt, but also with an organic solvent or solvent mixture. The salt and the solvent(s) are trapped in the polymer, which is then said to be plasticized. The gelled catholyte may also act as a separator for the positive and negative electrodes, and is thus not coupled to a conventional liquid electrolyte separator. On the other hand, the difference lies in the cycling temperature, since this type of electrolytic membrane functions at room temperature.

The polymeric binders may be, for example, polyethers, polyesters or polyfluoro compounds. Preferably, the polymeric binder is selected from:
homopolymers and copolymers of ethylene oxide (e.g. POE, POE copolymer), of methylene oxide, of propylene oxide, of epichlorohydrin, of allyl glycidyl ether;
halogenated polymers such as homopolymers and copolymers of vinyl chloride, of vinylidene fluoride (PVdF), of vinylidene chloride, of ethylene tetrafluoride or of chlorotrifluoroethylene, and copolymers of vinylidene fluoride and of hexafluoropropylene (PVdF-co-HFP);
homopolymers and copolymers of (meth)acrylate such as poly(methyl methacrylate);
and mixtures thereof.

A catholyte that is in gelled state at 25° C. may comprise from about 20% to 70% by mass of polymeric binder, and preferably from about 30% to 60% by mass of polymeric binder, relative to the total mass of the gelled polymeric electrolyte.

In the context of a solid catholyte, it may comprise an alloy based on lithium, germanium and/or silicon. Preferably, the catholyte includes an alloy selected from: Li₂SP₂S₅, Li₂S—P₂S₅—Li, Li₂S—P₂S₅—LiBH₄ and Li₂S—GeS₂—P₂S₅, or other formulations of ceramics of the family Li₂S-x-P₂S₅ (with x sulfide, oxide, selenide or halide). Also, the ceramic electrolyte may be composed of heterogeneous metal sulfides in amorphous (vitreous) or crystalline form.

Ceramic compounds based on metal oxide may also be used. More preferably, the ceramic solid electrolyte is selected from formulations of the type Li₂S-x-P₂S₅ (with x sulfide, oxide, selenide or halide).

The catholyte may contain other additives, the components of which do not contribute toward the capacity of the system. These additives are generally present in proportions of less than 20% by weight of the total mass of the catholyte, preferably less than 10%.

The catholyte may contain additives for protecting the interfaces of lithium or the carbon-sulfur composite material. For example, the catholyte may include additives selected from:

nitrogenous additives such as lithium nitrate (LiNO₃), which is very efficient for eliminating the shuttle mechanism on account of the passivation of the surface of the lithium, or nitromethane (CH₃NO₂); an FSI anion of the salt LiFSI may also participate in this passivation effect;
organic polysulfide compounds of general formula P₂Sₓ such as phosphorus pentasulfide (P₂S₅), which are capable of limiting the irreversible deposition of Li₂S on the lithium metal electrode, with x an integer greater than or equal to 2;
one or more electrical conductors, advantageously a carbon-based electrical conductor, such as carbon black, graphite or graphene, generally in proportions which may range from 1% to 10% by weight relative to the sulfur-based material. Preferably, carbon black is used as electrical conductor; and/or
one or more electron-donating elements to improve the electron exchanges and to regulate the length of the polysulfides during charging, which optimizes the charging/discharging cycles of the battery. Use may advantageously be made, as electron-donating elements, of an element, in powder form or in salt form, from columns IVa, Va and VIa of the Periodic Table, preferably chosen from Se, Te, Ge, Sn, Sb, Bi, Pb, Si and As.

These additives are generally present in proportions of between 0.5% and 5% by weight of the total mass of catholyte.

The catholyte described previously may contain one or more organic solvents in variable proportions.

The organic solvent may be selected, for example, from: a monomer, an oligomer, a polymer and a mixture thereof. In particular, the organic solvent includes at least one compound selected from: an amide, a carbonate ester, an ether, a sulfone, a ketone, a fluoro compound, a sulfoxide-amide, toluene and a sulfoxide. The amide is preferably selected from N-methyl-2-pyrrolidone (NMP) and N,N-dimethylformamide (DMF). The sulfoxide is preferably dimethyl sulfoxide. The dimethyl sulfoxide may advantageously be used in combination with lactones (preferably γ-butyrolactone and valerolactone), pyrrolidones (e.g. NMP or 2-pyrrolidone), sulfonamides or ketones (e.g. acetone, trimethylcyclohexanone, cyclohexanone).

The organic solvent is preferably a solvent suitable for lithium-sulfur batteries. Thus, preferably, the organic solvent includes at least one compound selected from: a carbonate ester, an ether, a sulfone, a fluoro compound and toluene.

Ethers notably make it possible to obtain good dissolution of the lithium polysulfides, even though they have dielectric constants that are generally lower than those of carbonates.

Thus, preferably, the organic solvent is selected from an ether such as 1,3-dioxolane (DIOX) or 1,2-dimethoxyethane (DME) or a carbonate ester such as dimethyl carbonate (DMC) or propylene carbonate (PC).

The organic solvent may also include a combination of solvents. For example, it may comprise an ether and a carbonate ester. This may make it possible to reduce the viscosity of a mixture including a high molecular weight carbonate ester.

Preferably, the organic solvent is selected from: 1,3-dioxolane (DIOX), 1,2-dimethoxyethane (DME), ethylene carbonate (EC), diethyl carbonate (DEC), propylene carbonate (PC), dimethyl carbonate (DMC), ethyl methyl carbonate (EMC), methyl propyl carbonate, tetrahydrofuran (THF), 2-methyltetrahydrofuran, methylpropyl propionate, ethylpropyl propionate, methyl acetate, diglyme (2-methoxyethyl ether), tetraglyme, diethylene glycol dimethyl ether (diglyme, DEGDME), polyethylene glycol dimethyl ether (PEGDME), tetraethylene glycol dimethyl ether (TEGDME), ethylene carbonate, propylene carbonate, butyrolactone, dioxolane, hexamethylphosphoamide, pyridine, dimethyl sulfoxide, tributyl phosphate, trimethyl phosphate, N-tetraethylsulfamide, sulfone, and mixtures thereof.

More preferably, the organic solvent is selected from: tetrahydrofuran, 2-methyltetrahydrofuran, dimethyl carbonate, diethyl carbonate, ethyl methyl carbonate, methyl propyl carbonate, methylpropyl propionate, ethylpropyl propionate, methyl acetate, dimethoxyethane, 1,3-dioxolane, diglyme (2-methoxyethyl ether), tetraglyme, ethylene carbonate, propylene carbonate, butyrolactone, dioxolane, hexamethylphosphoamide, pyridine, dimethyl sulfoxide, tributyl phosphate, trimethyl phosphate, N-tetraethylsulfamide, sulfone, and mixtures thereof.

Other solvents may also be used, for instance sulfones, fluoro compounds or toluene.

Preferably, the organic solvent is a sulfone or a mixture of sulfones. Examples of sulfones are dimethyl sulfone and sulfolane. Sulfolane may be used as sole solvent or as a combination, for example, with other sulfones. In one embodiment, the electrolyte liquid solvent comprises lithium trifluoromethanesulfonate and sulfolane. Alternatively, the catholyte may also be formulated without solvent.

### The Electrodes

In the context of the present invention, the cathode 30 comprises sulfur that is capable of inserting/deinserting a salt such as sodium or lithium or of forming an alloy therewith.

During charging, the sodium or lithium ions are deinserted by oxidation of the anode 10, cross the separator 20 and migrate across the catholyte 40, the ion conductor, to the cathode 30, generally based on a carbon-based material, which is reduced with insertion of these ions.

Simultaneously, the electrons released at the anode 10 rejoin the cathode 30 via the external circuit.

During the first insertion into the material of the cathode or the first formation of the alloy with the material of the cathode, a portion of the salt (e.g. sodium or lithium) initially contained in the anode is irreversibly consumed.

As shall be presented in the examples, the inventors have developed a novel battery having, firstly, greatly increased capacity and, secondly, the advantage of not requiring a first cycle of slow formation which may entail a loss of capacity.

### The Cathode

As has been mentioned, the battery according to the invention has a higher specific capacity than the specific capacity observed for sulfur-based batteries of this type. A literature study notably shows that the Li—S batteries developed have initial discharging capacities that are all less than 1670 mAh/g, with a majority of the initial discharging capacities of the order of 1000 mAh/g. Thus, the current systems do not manage to use the full potential of the sulfur and generally have non-optimal initial discharging capacities.

In contrast, in the context of the present invention, the cathode advantageously has a specific capacity of greater than 1300 mAh/g. To check this feature, the specific capacity of the cathode may be measured at a discharging regime equal to C/10 and at a temperature of 20° C. Conventionally, these values depend on the mass of sulfur present in the cathode.

Preferably, the cathode has a specific capacity of greater than 1500 mAh/g and more preferably greater than 2000 mAh/g.

In addition, to present such features, the cathode also has a theoretical specific capacity of greater than 1672 mAh/g. Thus, the present invention makes it possible to go beyond the true potential of the sulfur present in the cathode.

Such features are notably possible due to the presence in the catholyte of the organosulfur species participating in the capacity of the cathode.

The cathode according to the invention also has good coulombic efficiency. It is, for example, greater than or equal to 95% and preferably greater than 98%.

As has been mentioned, the cathode comprises a composite material based on sulfur and carbon-based material.

The composite material based on sulfur and carbon-based material may also include other compounds such as the additives detailed below.

The composite material based on sulfur and carbon-based material (i.e. sulfur-carbon composite material) has preferably been obtained according to a melt-route process, for instance in the context of a process including a compounding step. A process for preparing a sulfur-carbon composite that is particularly advantageous in the context of the invention is described in WO 2016/102865.

For optimum formation of the composite material, the carbon-based material such as carbon nanotubes and/or carbon black is mixed with the sulfur, in the melt. To do this, it is generally necessary to add intense mechanical energy to perform this mixing, which may be between 0.05 kWh/kg and 1 kWh/kg of active material, preferably between 0.2 and 0.5 kWh/kg of active material. The carbon-based material is thus dispersed homogeneously throughout the bulk of the particles, and is not found solely at the surface of the sulfur-based particles.

Advantageously, the sulfur-carbon composite is obtained via a manufacturing process including a step of melting the sulfur and of blending the sulfur and the carbon-based material. This melting and blending step may be advantageously performed with a compounding device. Thus, as presented in FIG. 2, the process according to the invention may include preliminary steps of forming the sulfur-carbon composite, said steps of forming the sulfur-carbon composite including:
introduction 110 into a compounding device of sulfur and of carbon-based material,
performing a compounding step 130 so as to allow the melting of the sulfur, and
blending 140 the molten sulfur and the carbon-based material.

To do this, use is preferentially made of a compounding device, i.e. apparatus conventionally used in the plastics industry for the melt blending of thermoplastic polymers and additives for the purpose of producing composites. The composite material based on sulfur and carbon-based material according to the invention may thus be prepared according to a process comprising the following steps:
(a) introduction 110 into a compounding device of sulfur and of carbon-based material,
(b) melting 130 of the sulfur;
(c) blending 140 the molten sulfur and the carbon-based material;
(d) recovery 150 of the mixture obtained in an agglomerated solid physical form; and
(e) milling in powder form.

In compounding apparatus, the sulfur and the carbon-based material are mixed using a high-shear device, for example a corotating twin-screw extruder or a co-kneader. The molten material generally leaves the apparatus in an agglomerated solid physical form, for example in the form of granules, or in the form of rods which, after cooling, are chopped into granules.

Examples of co-kneaders that may be used are the Buss® MDK 46 co-kneaders and those of the Buss® MKS or MX series, sold by the company Buss AG, which all consist of a screw shaft provided with flights which is positioned in a heating barrel optionally consisting of several parts, the internal wall of which is provided with kneading teeth suitable for interacting with the flights so as to shear the kneaded material. The shaft is driven in rotation and provided with an oscillating movement in the axial direction by a motor. These co-kneaders may be equipped with a system for manufacturing granules, for example attached to their outlet orifice, which may consist of an extrusion screw or a pump.

The co-kneaders that may be used preferably have a screw ratio L/D ranging from 7 to 22, for example from 10 to 20, while the corotating extruders advantageously have an L/D ratio ranging from 15 to 56, for example from 20 to 50.

In order to achieve optimal dispersion of the carbon-based material in the sulfur, it is preferable to apply a large amount of mechanical energy, which is preferably greater than 0.05 kWh/kg of material.

The compounding step is performed at a temperature above the melting point of sulfur. Thus, the compounding temperature may range from 120° C. to 150° C.

This process makes it possible to efficiently and homogeneously disperse a large amount of carbon-based material in the sulfur, despite the difference in density between the constituents of the composite material.

The composite material according to the invention is advantageously in the form of a powder comprising particles with a mean size of less than 150 μm, preferably less than 100 μm, a median diameter d50 of between 1 and 60 μm, preferably between 10 and 60 μm, more preferentially between 20 and 50 μm, a median diameter d90 of less than 100 μm, preferably a diameter d100 of less than 50 μm, these features being determined by laser diffraction. To obtain this powder morphology, use is generally made of apparatus such as a hammer mill, brush mill or ball mill, an air jet mill or of other methods for the micronization of solid materials.

### The Sulfur Used for the Composite Material

According to a preferred embodiment of the invention, the sulfur used for forming the composite material comprises at least sulfur in elemental form and/or at least one sulfur-based material.

Thus, the composite material may include sulfur in elemental form alone, at least one other sulfur-based material or mixtures thereof.

Various sources of sulfur in elemental form are commercially available. The particle size of the sulfur powder may vary within wide ranges. The sulfur may be used as is or the sulfur may be purified beforehand according to different techniques, such as refining, sublimation or precipitation. The sulfur or more generally the sulfur-based material may also be subjected to a preliminary step of milling and/or screening in order to reduce the size of the particles and to narrow their distribution.

The sulfur-based material may be an organosulfur compound or polymer, or an inorganic sulfur-based compound or a mixture thereof in all proportions.

The sulfur-based inorganic compounds that may be used as sulfur-based materials are, for example, alkali metal anionic polysulfides, preferably the lithium polysulfides represented by the formula Li₂Sₙ (with n≥1).

The organosulfur compounds or polymers that may be used as sulfur-based materials are, for example: polyDMDO, polysulfide-DMDO, polyphenylene disulfide copolymers, and any other polymer containing disulfide —S—S— or polysulfide —Sₙ— sequences within the main polymer chain and —SH groups in the functionalities.

The sulfur used to form the sulfur-carbon composite according to the invention may have various heat of fusion values. This heat of fusion (Δ H_{fus}) may preferably be between 70 and 100 J·g⁻¹. Specifically, the sulfur-based material, for example in elemental form or in the form of an aromatic polysulfide, may be characterized by a heat of fusion measured during a phase transition (melting) by differential scanning calorimetry (DSC) of between 80° C. and 130° C. Following the implementation of the process according to the invention, and notably the incorporation of the carbon-based nanofillers in the melt, there is a decrease in the enthalpy value (Δ H_{fus}) of the composite relative to the enthalpy value of the original sulfur-based material.

The composite material may comprise from about 30% to 90% by mass of sulfur, preferably from about 50% to 90% by mass of sulfur and more preferably from about 70% to 90% by mass of sulfur, relative to the total mass of composite material.

### The Carbon-Based Material Used for the Composite Material

According to the invention, the carbon-based material may be selected from: carbon black, carbon nanotubes (CNT), carbon nanofibers, graphene, acetylene black, graphite, carbon fibers and a mixture thereof in all proportions. Advantageously, the carbon-based material is selected from: carbon nanotubes (CNT), carbon nanofibers, graphene and a mixture thereof in all proportions.

Preferably, the carbon-based material includes at least carbon nanotubes or carbon nanofibers. This means that the carbon-based material may correspond to carbon nanotubes and carbon nanofibers, alone or mixed with at least one other carbon-based nanofiller. Specifically, unlike carbon black, the additives of CNT type have the advantage of also conferring an adsorbent effect that is beneficial to the active material by limiting its dissolution in the electrolyte and thus promoting better cyclability. The carbon-based nanofiller may correspond here to carbon black, graphene, acetylene black, graphite, carbon fibers, and a mixture thereof in all proportions.

The composite material may comprise from about 10% to 70% by mass of carbon-based material, preferably from about 10% to 50% by mass of carbon-based material and more preferably from about 10% to 30% by mass of carbon-based material, relative to the total mass of composite material.

The CNTs included in the composition of the composite material may be of the single-walled, double-walled or multi-walled type, preferably of the multi-walled-type (MWNT).

The carbon nanotubes used according to the invention usually have a mean diameter ranging from 0.1 to 200 nm, preferably from 0.1 to 100 nm, more preferentially from 0.4 to 50 nm and better still from 1 to 30 nm, or even from 10 to 15 nm, and advantageously have a length of more than 0.1 μm and advantageously from 0.1 to 20 μm, preferably from 0.1 to 10 μm, for example about 6 μm. Their length/diameter ratio is advantageously greater than 10 and usually greater than 100. Their specific surface area is, for example, between 100 and 300 m²/g, advantageously between 200 and 300 m²/g, and their apparent density may notably be between 0.01 and 0.5 g/cm³ and more preferentially between 0.07 and 0.2 g/cm³. The MWNTs may comprise, for example, from 5 to 15 sheets and more preferentially from 7 to 10 sheets.

The carbon nanotubes are notably obtained by chemical vapor deposition, for example according to the process described in WO 06/082325. Preferably, they are obtained from renewable starting material, in particular of plant origin, as described in patent application EP 1 980 530.

These nanotubes may or may not be treated.

An example of crude carbon nanotubes is notably the trade name Graphistrength® C100 from the company Arkema.

These nanotubes may be purified and/or treated (for example oxidized) and/or milled and/or functionalized.

The milling of the nanotubes may notably be performed under cold or hot conditions and may be performed according to the known techniques employed in apparatus such as ball mills, hammer mills, edge runner mills, knife mills or gas jet mills or any other milling system that is capable of reducing the size of the entangled network of nanotubes. It is preferable for this milling step to be performed according to a gas jet milling technique and in particular in an air jet mill.

The crude or milled nanotubes may be purified by washing using a sulfuric acid solution, so as to free them from possible residual mineral and metallic impurities, for instance iron, originating from their preparation process. The weight ratio of the nanotubes to the sulfuric acid may notably be between 1:2 and 1:3. The purification operation may moreover be performed at a temperature ranging from 90° C. to 120° C., for example for a period of from 5 to 10 hours. This operation may advantageously be followed by steps in which the purified nanotubes are rinsed with water and dried. As a variant, the nanotubes may be purified by high-temperature heat treatment, typically above 1000° C.

Oxidation of the nanotubes is advantageously performed by bringing them into contact with a sodium hypochlorite solution containing from 0.5% to 15% by weight of NaOCl and preferably from 1% to 10% by weight of NaOCl, for example in a weight ratio of the nanotubes to the sodium hypochlorite ranging from 1:0.1 to 1:1. The oxidation is advantageously performed at a temperature below 60° C. and preferably at room temperature, for a period ranging from a few minutes to 24 hours. This oxidation operation may advantageously be followed by steps in which the oxidized nanotubes are filtered and/or centrifuged, washed and dried.

Functionalization of the nanotubes may be performed by grafting reactive units, such as vinyl monomers, to the surface of the nanotubes.

Use is preferably made in the present invention of crude, optionally milled carbon nanotubes, that is to say nanotubes which are neither oxidized nor purified nor functionalized and which have not undergone any other chemical and/or heat treatment.

The carbon nanofibers that may be used as carbon-based material in the present invention are, like the carbon nanotubes, nanofilaments produced by chemical vapor deposition (or CVD) starting from a carbon-based source which is decomposed on a catalyst including a transition metal (Fe, Ni, Co, Cu), in the presence of hydrogen, at temperatures of from 500° C. to 1200° C. However, these two carbon-based fillers differ in their structure since the carbon nanofibers are composed of more or less organized graphite regions (or turbostratic stacks), the planes of which are inclined at variable angles relative to the axis of the fiber. These stacks may be in the form of stacked platelets, fishbones or dishes to form structures with a diameter generally ranging from 100 nm to 500 nm or even more.

Examples of carbon nanofibers that may be used in particular have a diameter of from 100 to 200 nm, for example about 150 nm, and advantageously a length of from 100 to 200 μm. Use may be made, for example, of the VGCF® nanofibers from Showa Denko.

The term “graphene” denotes a flat, isolated and separate graphite sheet but also, by extension, an assembly comprising between one and a few tens of sheets and having a flat or more or less wavy structure. This definition thus encompasses FLGs (Few Layer Graphene), NGPs (Nanosized Graphene Plates), CNSs (Carbon NanoSheets) and GNRs (Graphene NanoRibbons). On the other hand, it excludes carbon nanotubes and nanofibers, which consist, respectively, of the winding of one or more graphene sheets coaxially and of the turbostratic stacking of these sheets. Furthermore, it is preferable for the graphene used according to the invention not to be subjected to an additional step of chemical oxidation or of functionalization.

The graphene used according to the invention is obtained by chemical vapor deposition or CVD, preferably according to a process using a pulverulent catalyst based on a mixed oxide. It is characteristically in the form of particles with a thickness of less than 50 nm, preferably of less than 15 nm and more preferentially of less than 5 nm, and with lateral dimensions of less than a micron, preferably from 10 nm to less than 1000 nm, more preferentially from 50 to 600 nm, or even from 100 to 400 nm. Each of these particles generally contains from 1 to 50 sheets, preferably from 1 to 20 sheets and more preferentially from 1 to 10 sheets, or even from 1 to 5 sheets, which are capable of being separated from each other in the form of independent sheets, for example during an ultrasonication treatment.

### Additives Used for the Composite Material

According to one embodiment of the invention, the composite material also comprises at least one additive chosen from a rheology modifier, a binder, an ion conductor, a carbon-based electrical conductor, an electron-donating element or a combination thereof. These additives are advantageously introduced during a step 120, prior to or during the compounding step, so as to obtain a homogeneous composite material. Thus, preferably, a rheology modifier is added to the compounding device, preferably before performing the compounding step.

In particular, it is possible to add, during the mixing, during the compounding step, an additive which modifies the rheology of the sulfur in molten form, in order to reduce the self-heating of the mixture in the compounding device. Such additives having a fluidizing effect on the liquid sulfur are described in patent application WO 2013/178930. Examples that may be mentioned include dimethyl sulfide, diethyl sulfide, dipropyl sulfide, dibutyl sulfide, dimethyl disulfide, diethyl disulfide, dipropyl disulfide, dibutyl disulfide, the trisulfide homologs thereof, the tetrasulfide homologs thereof, the pentasulfide homologs thereof, the hexasulfide homologs thereof, alone or as mixtures of two or more thereof in all proportions.

The amount of rheology-modifying additive is generally between 0.01% to 5% by weight, preferably from 0.1% to 3% by weight relative to the total weight of the carbon-sulfur composite.

The composite material may comprise a binder, notably a polymeric binder. Thus, it is also possible to add during the formation of the composite material a polymeric binder as defined previously.

The composite material may comprise an electrical conductor and/or an electron-donating element in order to improve the electronic exchanges and to regulate the length of the polysulfides during charging, which optimizes the charging/discharging cycles of the battery.

These additive compounds may generally be added in proportions that may range from 1% to 10% by weight relative to the weight of sulfur-based material.

Advantageously, the composite material based on sulfur and carbon-based material may also comprise selenium. The selenium may be in the form of mineral or organic selenium (e.g. organoselenium compounds).

The composite material may comprise from about 0.1% to 10% by mass of selenium, preferably from about 0.1% to 5% by mass of selenium and more preferably from about 0.1% to 2% by mass of selenium, relative to the total mass of composite material.

The composite material may comprise from 1% to 50% by mass of ceramic of the type Li₂S-x-P₂S₅, preferably from 5% to 30% (with x sulfide, oxide, selenide or halide).

### Constitution of the Cathode

Thus, the cathode according to the invention includes a composite material based on sulfur and carbon-based material.

Advantageously, the cathode may comprise from about 30% to 95% by mass of composite material.

In addition, the cathode according to the invention may notably comprise one or more polymeric binders and one or more metal salts.

### The Polymeric Binder

The cathode may comprise a polymeric binder that is capable of improving the physicochemical and mechanical properties thereof.

The polymeric binder may be chosen from ethylene homopolymers and copolymers; propylene homopolymers and copolymers; homopolymers and copolymers of ethylene oxide (e.g. POE, POE copolymer), of methylene oxide, of propylene oxide, of epichlorohydrin, of allyl glycidyl ether, ethylene oxide tert-octylphenyl ether of formula C₁₄H₂₂O(C₂H₄O)ₙ, the polyallylamines of formula R(C₃H₅NH₂)ₙ, polymers of lactones, such as caprolactone P(_{ε}CL)ₙ, polymers of trimethylene carbonate P(TMC)ₙ, or oligomers of caprolactone and of trimethylene carbonate P(_{ε}CLₙ-co-TMCₘ) of formula CH₃(C₆H₁₀O₂)ₘ(C₄H₆O₂)ₙCH₃, starburst copolymers of the type [P(OEₙ-co-OPₘ) acrylate]4, in which OE is ethylene oxide and OP is propylene oxide, P[_{ε}CLₙ-co-(AGE-g-MePEG₇)ₘ] in which AGE is allyl glycidyl ether and MePEG is methylpolyethylene glycol (O—CH₂—CH₂)₇—O—CH₃, P(SF₄-g-MePEG₇)ₙ-b-PSₘ in which PS is a polystyrene group, SF₄ is a CH₂—CH₂—C₆F₄—O—CH₂—CH₂ group. Finally, in general, any polymer obtained by polymerization of at least one cyclic monomer including in the cyclic chain a heteroatom chosen from oxygen, nitrogen, phosphorus, silicon and sulfur atoms, which may be in a nonlimiting manner of lactone, carbonate, lactide or alkylene oxide type, and mixtures thereof; halogenated polymers such as homopolymers and copolymers of vinyl chloride, of vinylidene fluoride (PVdF), of vinylidene chloride, of ethylene tetrafluoride or of chlorotrifluoroethylene, copolymers of vinylidene fluoride and of hexafluoropropylene (PVdF-co-HFP) or mixtures thereof; polyacrylates such as polymethyl methacrylate; polyalcohols such as polyvinyl alcohol (PVA); electron-conducting polymers such as polyaniline, polypyrrole, polyfluorenes, polypyrenes, polyazulenes, polynaphthalenes, polyacetylenes, poly(p-phenylene-vinylene), polycarbazoles, polyindoles, polyazepines, polythiophenes, p-phenylene polysulfide, or mixtures thereof; polymers of cationic type such as polyethyleneimine (PEI), polyaniline in emeraldine salt (ES) form, poly(quaternized N-vinylimidazole), poly(acrylamide-co-diallyldimethylammonium chloride) (AMAC) or mixtures thereof; polymers of anionic type such as poly(styrene sulfonate), gelatin or pectin; and a mixture thereof.

According to a particular embodiment, the cathode comprises from about 1% to 30% by mass of polymeric binder, and preferably from about 5% to 10% by mass of polymeric binder, relative to the total mass of the cathode.

### The Metal Salt

The cathode may also comprise at least one metal salt. Preferably, the at least one metal salt is selected from lithium and sodium salts.

More preferably, the cathode may also comprise at least one lithium salt.

The lithium salt may be chosen from the salts already presented during the description of the catholyte.

Among the electrolyte salts, salts such as LiTFSI, LiPF₆, LiFSI, LiTDI, LIBOB, LIDFOB, LiBF₄, LiClO₄, LiAsF₆, and mixtures thereof are preferably chosen.

LiTFSI or LiFSI is the preferred lithium salt.

The cathode may comprise from about 1% to 25% by mass of metal salt, preferably from about 1% to 15% by mass of metal salt and more preferably from about 1% to 10% by mass of metal salt, relative to the total mass of the cathode.

The cathode according to the invention may be manufactured via any conventional method.

For example, the cathode may be prepared by mixing a composite material, based on sulfur and carbon-based material, with at least one polymeric binder, optionally at least one metal salt, and optionally at least one solvent for said polymeric binder, to obtain an electrode ink. The electrode ink may then be applied to at least one support.

The solvent for the polymeric binder may be chosen from water, N-methylpyrrolidone, solvents of carbonate type such as ethylene carbonate, propylene carbonate, dimethyl carbonate, diethyl carbonate or methyl ethyl carbonate, acetone, alcohols such as methanol, ethanol or propanol, and mixtures thereof.

The application of the electrode paste may be performed by rolling or by coating. The application may be performed on a current collector and/or a support film. The current collector may include, for example, an aluminum foil. The support film may be, for example, a plastic film of siliconized polyethylene terephthalate (PET) type.

The process for manufacturing the cathode according to the invention may include a step of drying the electrode paste to obtain a positive electrode in supported film form.

In addition, the process for manufacturing the cathode may comprise a step of calendering or of extrusion.

The cathode according to the invention may have a thickness ranging from 2 to 100 mm and preferably from 10 to 60 mm.

### The Separator

Conventionally, the separator 20 is placed between the anode 10 and the cathode 30 and more particularly between the catholyte 40 and the anode 10.

The separator generally ensures perfect insulation between the two electrodes to avoid any risk of short-circuiting. It advantageously has a mechanical strength that is sufficient to withstand the stresses due to the variations in volume of the active materials during the charging and discharging cycles, chemical resistance that is sufficient to ensure its resistance over time since it is immersed in the electrolyte, and a suitable porous structure, to permit diffusion of the anions and cations of the electrolyte, and to prevent any transport of active material from one electrode to the other.

The separator corresponds, for example, to an intermediate separating element placed between the anode and the cathode, which acts to separate the liquid or gel electrolyte solutions in contact with the anode and the cathode, via which the metal ions and the counterions thereof move between the anode and the cathode.

The separator may be in the form of a solid electrolyte or of a separator 20 impregnated with a liquid catholyte.

The separator used in the organic lithium battery of the invention also ensures the electrical separation of the electrodes, while at the same time preventing or limiting the diffusion of the organic redox structure of the positive electrode in the battery. In addition, the separator is stable with respect to the electrolyte of the battery, whether said electrolyte is in liquid or solid form (e.g. gelled polymeric electrolyte). Preferably, part of its structure is unreactive relative to the organic or mineral sulfur species.

The separator is generally made of a porous material that is not electrically conductive, for example made of a polymer material based on polyolefins (e.g. polyethylene) or made of fibers (e.g. glass fibers or wood fibers).

In a particular embodiment, the porous separator has pores with a mean size ranging from about 50 nm to 3 μm, preferably from about 50 nm to 1 μm and more preferably from about 100 nm to 500 nm. By virtue of this porosity, said separator can be readily impregnated with the electrolyte while at the same time ensuring sufficient mechanical strength.

The polypropylene of the porous separator may be a polypropylene homopolymer (PP) or a polypropylene copolymer.

The porous separator may be impregnated with polymers or copolymers of DMDO, Ph-S—S—R or other functionalities mentioned in the “cathode” section.

The separator may include an organofluorine species such as polyvinylidene fluoride (PVDF) and copolymers or terpolymers, typical representatives of which are PVDF-TrFE (trifluoroethylene) copolymers or PVDF-TrFE-CTFE (chlorotrifluoroethylene) terpolymers.

The separator advantageously includes one or more ceramic alloys. The ceramic may be associated with the separator by deposition, for example by laser deposition (laser pulsed deposition).

### The Anode

The battery according to the invention also includes an anode. In particular, the anode may comprise an anode active material comprising sodium or lithium. The anode active material is preferably a composite material based on sodium or lithium or an alloy based on sodium or lithium.

The anode active material may correspond, for example, to material of lithium-metal type or to a lithiated silicon (e.g. silicon covered with lithium, for example by electrolysis).

### The Process for Preparing the Battery

A subject of the invention is also a process for manufacturing a sulfur-based battery as defined in the first subject of the invention, characterized in that it comprises a step of preparing a catholyte as defined in the present invention notably including at least one organosulfur species participating in the capacity of the cathode and a step of assembling an anode, a cathode and a porous separator as defined in the present invention.

When the organosulfur species includes a thiol function, the preparation of the catholyte may first include a step of reducing the organosulfur species by placing in contact with mineral lithium.

Preferably, the preparation of the catholyte also includes the dissolution with stirring of at least one lithium salt in an organic solvent, optionally at a temperature ranging from about 20 to 120° C.

The process may include a step of impregnating the separator prior to the assembly step. Impregnation of the separator with the catholyte may be performed by roll-bonding of the separator and of a film of gelled catholyte.

The process may also comprise a step of mounting the anode with the positive cathode, the separator and the catholyte to form an electrochemical cell.

The battery can then be charged and various cycles are performed.

Following assembly, sulfur-based batteries generally require a preliminary forming step. During this forming step, the batteries undergo long charging and discharging cycles to create the interfaces required for their subsequent functioning. However, advantageously, such is not the case for the battery according to the invention.

Thus, preferably, in the context of the invention, the process for manufacturing the battery according to the invention does not require a forming step.

As illustrated in the examples below, the present invention provides a solution based on the reactivity of the catholyte including an organosulfur species for improving the capacity of Li—S batteries while at the same time conserving stability of the system.

### Example 1—Preparation of a Sulfur/CNT Composite Material

The sulfur/CNT composite material (or “compound”) is prepared according to the method described in patent application WO 2016/102865.

Nanotubes (Graphistrength C100 from Arkema) and solid sulfur (50-800 microns) were introduced into the first feed hopper of a Buss MDK 30 (L/D=15) co-kneader equipped with a discharge extrusion screw and a granulation device.

The nominal temperature values in the co-kneader were as follows: Zone 1: 140° C.; Zone 2: 130° C.

At the die outlet, the mixture, consisting of 87% by weight of sulfur and 13% by weight of nanotubes, is in the form of granules obtained by pelletizing, cooled with air. The composite material is characterized by a density of 1.55 g/cm³ and an apparent density of 1.05 g/cm³. Another feature specific to the composite material is the heat of fusion of sulfur measured by DSC (the Δ H_{fus} value was measured between 90 and 130° C.). For the starting sulfur, Δ H_{fus}=72 J g⁻¹. After compounding, the granules of composite material have a value of 54 J g⁻¹.

Milling of the granules was performed in a hammer mill under nitrogen. The composite material powder obtained is characterized by a D50<50 μm and an apparent density of 0.9 g/cm³. This sulfur/CNT composite material powder is then used as cathode active material in the Li/S battery.

### Example 2—Preparation of the Sulfur-Based Cathode of Reference 1

The mixture of (S/CNT):carbon black:PVDF=60:30:10 is mixed in N-methyl-2-pyrrolidone to form an ink. The ink of semi-fluid consistency is deposited in thin layers directly onto carbon paper and dried for 3 hours at 60° C. The mass of sulfur active material is then calculated by evaluating the amount deposited according to the percentage reported above. The sulfur active mass values are generally between 0.8 mg and 2 mg per 1 cm².

The battery elements: separator, cathode, are dried at 80° C. under vacuum for 24 hours and then assembled in glove boxes.

### Example 3—Preparation of the Electrode of Reference 2 Based on the Active Material of Example 1 on Aluminum Foil

An ink was formed according to example 2 and then deposited onto an aluminum foil via technology of scraper type (e.g. doctor blade). The film thus obtained was dried at 120° C. for 20 minutes in an oven to obtain a cathode.

### Example 4—Preparation of the Electrode of Reference 3 Based on the Self-Supported Active Material of Example 1 Deposited on an Aluminium Grate

The mixture of (S/CNT):carbon black:PTFE=45:45:10 is mixed in N-methyl-2-pyrrolidone/ethanol to form a paste. The mixture of semisolid consistency (paste) is formed into shape by simple pressing, between aluminum grate at 3 tons for optimum adhesion.

### Example 5—Preparation of a Liquid Catholyte

Two lithium salts LiNO₃ and LiTFSI (0.25 M/0.75 M) were mixed with a solvent base consisting of a DOL:DME binary mixture. A liquid electrolyte containing 1M of lithium salt in DOL:DME was thus obtained. The water content is controlled and should not exceed 20 ppm.

The electrolyte is optionally supplemented with an organosulfur species (e.g. 0.2 M). Depending on the nature of the organosulfur species, it is important to convert its concentration into a concentration of thiolate functions (e.g. 0.4 M RS—).

In the case where the organosulfur species is a thiol (e.g. R—SH) or a polythiol, it is preferable to perform a preliminary ex situ reduction 24 hours before assembly, under an inert atmosphere with lithium metal by adding an excess of lithium metal to the mixture of solvents/salts+R—SH prepared previously. The reaction is complete and leads to the formation of the corresponding lithium thiolate.

For example, for 1.3 mg of sulfur in the cathode and 100 μL of electrolyte based on DMDO, i.e. 0.2 mol/L, there are then 0.02 mmol of dithioles, i.e. 0.04 mmol of RS— functions per 1.3 mg of sulfur. The ratio S/RS— may then be 1.

The amount of active material in the electrode is 1.75 mg of S, i.e. 0.05 mmol.

The proportion of mineral sulfur/organic sulfur (sulfur originating from the organosulfur species participating in the capacity of the electrode) is equal or substantially equal to 1.25.

### Example 6—Preparation of a Solid Catholyte

The solid catholyte is prepared from the constituents presented in example 5, except for the presence in the solution of PVDF-co-HFP copolymer.

In addition, the catholyte is prepared by extrusion of the mixture, followed by rolling of the ink obtained at 125° C. between two plastic films.

### Example 7—Preparation and Testing of Li/S Batteries

Assembly is performed by superposition of the lithium anode, of the separator impregnated with the catholyte according to example 5 and then of the sulfur-carbon cathode in a glove box.

The batteries Ref. 1, Ref. 2 and Ref. 3 are not in accordance with the invention since there is no organosulfur species participating in the capacity of the cathode in the catholyte.

Batteries I1 to I5 are in accordance with the invention and have different compounds and also different concentrations. They are based on the electrodes formed according to example 2.

The discharge curves are measured at room temperature, the current imposed on the first discharge (extraction of sulfur) is equivalent to a C/10 regime (10 hours of discharging). The cycling of the cells thus prepared may also take place at higher temperature (45 to 50° C.).

### Example 8—Properties of the Batteries Studied

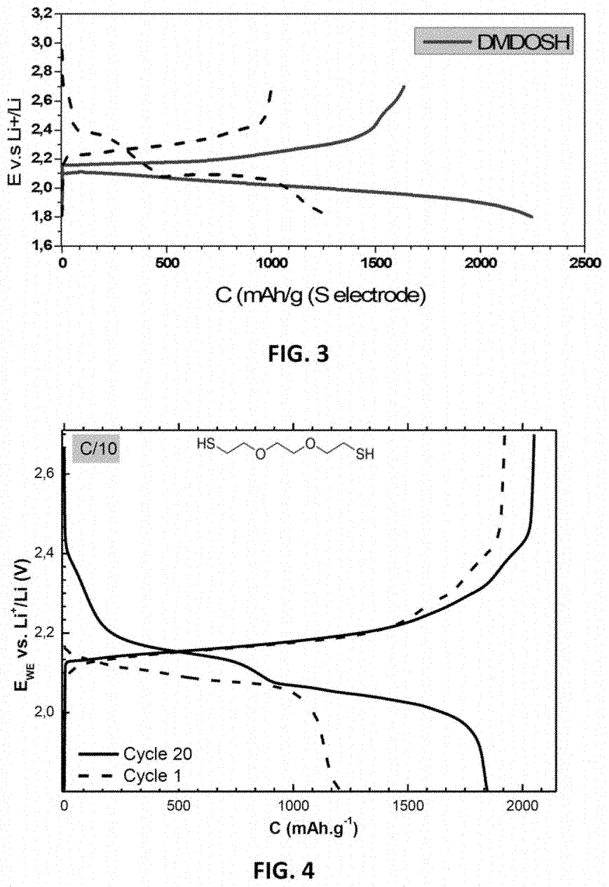

An example of a charging/discharging galvanostatic curve representing the initial discharging capacity obtained for a reference battery and a battery according to the invention, including 0.4 M DMDO as organosulfur species, is presented in FIG. 3 and a summary of the results obtained is presented in the table below:

| | | Concentration | | | Initial |
|---|---|---|---|---|---|
| | | of the | Mineral | Theoretical | discharging |
| | Organosulfur | organosulfur | sulfur in the | capacity of | capacity |
| Cathode | species | species | catholyte | the system | C/10 |
| Ref. 1 | None | 0 | 0 | 1672 | 850 |
| (Ex. 2) | | | | | |
| Ref. 2 | None | 0 | 0 | 1672 | <1000 |
| (Ex. 3) | | | | | |
| Ref. 3 | None | 0 | 0 | 1672 | <1000 |
| (Ex. 4) | | | | | |
| I1 | Ph—S—S—Ph | 0.2M | 0 | 2562 | 2400 |
| I2 | DMDO | 0.2M | 0 | 2280 | 1833 |
| I3 | DMDS | 0.2M | 0 | 2492 | 2238 |
| I4 | (CF₃)₂Ph—SH | 0.2M | 0 | 2322 | 1600 |
| I5 | TPS44 | 0.2M | 0 | 2482 | 2200 |

Thus, the presence of at least one organosulfur species in the catholyte makes it possible to significantly increase the initial discharging capacity of the battery. Specifically, all the examples according to the invention have initial discharging capacities at a C/10 regime that are much higher than the initial discharging capacity values at a C/10 regime of the comparative examples (Ref. 1, Ref. 2, Ref. 3). The increase compared with Ref. 1 based on the same electrode may reach more than 280% (cf. Ref. 1 versus I1). Furthermore, the discharging capacity at a regime of C is also improved with an increase that may reach more than 500% (cf. Ref. 1 versus I1).

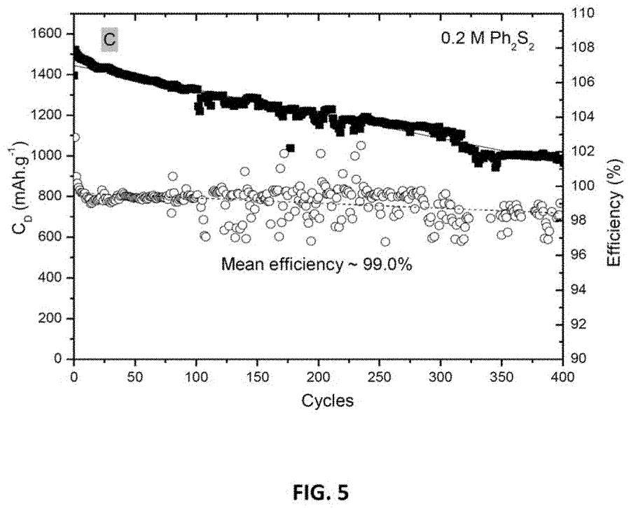

FIG. 4 also shows that the capacity of the battery increases in the course of the cycles performed in the presence of 0.2 M DMDO. FIG. 5, for its part, shows over 400 cycles, for a battery according to the invention including diphenyl disulfide, excellent efficiency of this battery and also discharging capacity levels that are much higher than the conventional levels.

Finally, the addition of sulfur in mineral form to the catholyte makes it possible to further increase the capacity of the battery according to the invention (result not shown).

### Example 8—Preparation of a Solid Catholyte in which the Organosulfur Species is Also a Polymeric Binder

The solid catholyte is prepared from the constituents presented in example 5 in which the organosulfur species is a polyDMDO. The catholyte is prepared by extrusion of the mixture, followed by rolling of the ink obtained at 125° C. between two plastic films.

1. A battery comprising an anode, a separator, a cathode comprising a composite material based on sulfur and carbon-based material, and a catholyte, wherein the catholyte includes at least one organosulfur species participating in the capacity of the cathode.

2. The battery as claimed in claim 1, wherein the anode comprises an anode active material comprising sodium or lithium.

3. The battery as claimed in claim 1, wherein the composite material has been formed in a melt, via a step of melting the sulfur and of blending the sulfur and the carbon-based material.

4. The battery as claimed in claim 1, wherein the carbon-based material is selected from: carbon black, carbon nanotubes, carbon fibers, graphene, acetylene black, graphite, carbon nanofibers and a mixture thereof in all proportions.

5. The battery as claimed in claim 1, wherein the composite material comprises sulfur in elemental form.

6. The battery as claimed in claim 1, wherein the composite material also includes selenium.

7. The battery as claimed in claim 1, wherein the at least one organosulfur species is selected from: an organic disulfide, an organic polysulfide, a thiol, a polythiol, a thiolate or a polythiolate.

8. The battery as claimed in claim 1, wherein the at least one organosulfur species is selected from the compounds having the following formulae: RSₓR, R(SH)ₙ, R(SM)ₓ, R(COSH)ₙ, R(COSM)ₙ, RCOSₓR and a polymer including one or more functions from among —Sₓ—, —COSₓ—, —SH, —SM, —COSH and —COSM,
with:
M selected from Li and Na;
R selected from substituted or unsubstituted alkyl or aryl groups,
x an integer greater than or equal to 2,
n an integer greater than or equal to 1.

9. The battery as claimed claim 1, wherein the catholyte also comprises:
one or more alkali metal salts,
mineral and organic polysulfide salts of A_{z}Sₓ and RSₓA, or
mixtures thereof,
with:
R selected from substituted or unsubstituted alkyl or aryl groups,
A selected from Li, Na, K, Rb and Cs,
x an integer greater than or equal to 2, and
z an integer greater than or equal to 2.

10. The battery as claimed in claim 1, wherein the catholyte also comprises one or more lithium salts and Li polysulfides:
with:
y an integer greater than or equal to 2, and
R selected from substituted or unsubstituted alkyl or aryl groups.

11. The battery as claimed in claim 1, wherein the catholyte may also comprise a polymeric binder.

12. The battery as claimed in claim 1, wherein the at least one organosulfur species is a polymer and is capable of behaving like a polymeric binder.

13. The battery as claimed in claim 12, wherein the at least one organosulfur species acting as a polymeric binder is selected from a polymer containing the following functions: disulfide —S—S—, polysulfides —Sₙ— with n an integer greater than or equal to 2, and/or —SH.

14. The battery as claimed in claim 1, wherein the organosulfur species participating in the capacity of the cathode are present in the catholyte in a concentration of greater than or equal to 0.05 mol/L.

15. The battery as claimed in claim 1, including mineral sulfur and organic sulfur, where the mole ratio between the mineral sulfur and the organic sulfur is between 0.05 and 10.

16. The battery as claimed in claim 1, wherein the cathode has a theoretical specific capacity of greater than 1700 mAh/g.

17. The battery as claimed in claim 1, wherein the cathode has a specific capacity of greater than 1300 mAh/g measured at a discharging regime equal to C/10.

18. The battery as claimed in claim 1, wherein the cathode has a specific capacity of greater than 500 mAh/g measured at a discharging regime equal to C/1.

19. The battery as claimed in claim 1, wherein the cathode is capable of having a specific capacity of greater than 1000 mAh/g measured at a discharging regime equal to C/1 after 400 cycles.

20. The battery as claimed in claim 1, where the battery does not require a forming step.

21. A process for manufacturing a battery as claimed in claim 1, the process comprising:
a step of preparing a catholyte including at least one organosulfur species participating in the capacity of the cathode and
a step of assembling an anode, a cathode, a separator and catholyte.

22. The manufacturing process as claimed in claim 21, wherein the process does not include a step of forming the battery after the assembly step.
